(19) United States
(12) Patent Application Publication
(10) Pub. No.: US 2009/0300017 A1
(43) Pub. Date: Dec. 3, 2009

(54) Transaction Parallel Control Method, and Database Managemet System

(75) Inventors: Yoshitaka TOKUSHO, New York, NY (US); Yukio Nakano, Oyama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/429,702

(22) Filed: Apr. 24, 2009

(30) Foreign Application Priority Data
Jun. 2, 2008 (JP) 2008-144670

(51) Int. Cl. G06F 17/30

(52) U.S. Cl. 707/8; 707/E17.007

(57) ABSTRACT

In a transaction parallel control method of a DBMS, if a priority of a transaction process accepted from an application is higher than a transaction process of an application being executed or suspended, a conflict is judged between database resources used by the both processes and a transaction process to be suspended or terminated is determined based on types and values of the database resources acquired by the respective processes. After the determined transaction process is suspended or terminated, the transaction process of the application is executed by acquiring a value corresponding to the type of the database resource included in the database resource acquisition schedule information accepted from the application and, after the completion, the suspended transaction is restarted.

### CROSS-REFERENCE TO RELATED APPLICATIONS

The present application claims priority from Japanese Patent Application No. 2008-144670 filed on Jun. 2, 2008, the content of which herein incorporated by reference.

### BACKGROUND

1. Field of the Invention

The present invention relates generally to a transaction parallel control method, a database management system, and a program, and, more particularly, to a technology for preventing data loss when a prioritized transaction process is generated.

2. Description of the Related Art

A database management system (DBMS) used with applications of information processing apparatuses such as portable telephones, car navigation systems, and digital consumer electronics is generally capable of parallel processing of transactions requested by a plurality of applications. For example, a portable telephone processes a transaction such as a phone-book search requested by a phone-book application in parallel while processing a transaction such as addition and reproduction of music contents requested by a music application. A car navigation system processes a transaction such as recording of traveling data requested by a vehicle management application in parallel while processing a transaction such as displaying latitude/longitude data on a map requested by a GPS application (GPS: Global Positioning System).

The transaction process refers to sequentially executing processes corresponding to one or more ordered queries. A typical relational database management system (RDBMS) uses SQL (structured query language) to execute the queries. For example, the queries are retrieval of data satisfying a certain condition from a database, addition (insertion) of data to a database, deletion of data satisfying a certain condition, update of data, generation of data, etc.

The transaction process is assured to achieve a result that all the query processes are executed or that none of the query processes is executed at the completion (atomicity of transaction). The transaction process is assured to achieve a valid state of database contents from a viewpoint of an application at the completion if the processing is initiated from a valid state of database contents from a viewpoint of an application (consistency of transaction). A means of assuring the consistency of transaction includes exclusive control using shared lock (reference lock) and exclusive lock. For this exclusive control, DBMS retains exclusive resource management information having a data structure for managing the states of the shared lock and the exclusive lock. Gray, J. and Reuter, A., “Transaction Processing: Concepts and Techniques”, Morgan Kaufmann Publishers, 1993 discloses the atomicity of transaction, the consistency of transaction, the shared lock, the exclusive lock, the exclusive resource management information (“lock manager data structure” in the literature), etc.

Mechanisms of the above parallel processing include a TSS mode (TSS: Time Sharing System) (see, e.g., Tanenbaum, A, S. and Woodhull, A., “Operating Systems: Design and Implementation 2nd Edition”, Chapter 2 “Process”, Prentice Hall, 1997), a prioritized preemptive mode, etc. Information processing apparatuses such as portable telephones, car navigation systems, and digital consumer electronics require the reduction of response time rather than the improvement of throughput. Therefore, the prioritized preemptive mode is normally employed.

In the prioritized preemptive mode, each of transaction processes is given a priority that is a value representing an execution order and the processes are executed in accordance with the following rules:

(a) the CPU use right is allocated to the transaction process with the highest priority at the time;

(b) among transaction processes with the same priorities, the CPU use right is first allocated to a transaction process requested earlier; and

(c) if a transaction process with a higher priority is generated, the CPU use right is switched to the transaction process with a higher priority even when a transaction process with a lower priority is being executed with the use of CPU.

The transaction parallel control with the prioritized preemptive mode includes a method of giving a higher priority to a transaction process with higher urgency or importance. In this method, if a request for a transaction process with a higher priority is generated while executing a transaction process, resources acquired by the transaction process with a lower priority are released to enable the transaction process with a higher priority to acquire necessary resources and the CPU usage right is switched to the transaction process with a higher priority. This enables the reduction of response time for processes with higher urgency or importance. For example, in the case of portable telephones, a higher priority is given to a transaction process requested by a phone-call application (such as display of voice reception) than transaction processes requested by a music application and a phone-book application and the transaction process requested by the phone-call application is executed when a phone call (voice reception) occurs while executing the transaction process requested by the music application. This enables the reduction of response time to the voice reception.

However, this method has the following problem. For example, in a portable telephone including a phone-call application executing a process for voice reception and a phone-book application referring to and updating a phone book, if voice reception occurs while the phone-book application is executing a transaction process of updating phone book data, the transaction process of the phone-book application must be terminated (rolled back) so as to allow the transaction process requested by the phone-call application to use the resources acquired by the phone-book application, and this causes the phone book data in process of update to be erased.

### SUMMARY

The present invention was conceived in view of the above problem and it is therefore the object of the present invention to provide a transaction parallel control method, a database management system, and a program capable of preventing data loss when a prioritized transaction process is generated.

In order to achieve the above object, according to a major aspect of the present invention there is provided a transaction parallel control method in a database management system used by applications, comprising the steps of receiving an instruction for requesting a transaction process from a first application and receiving transaction identifier information including an identifier of the transaction process, priority definition information including a priority of the transaction process, and database resource acquisition schedule information including a type and a value of a database resource to be acquired at the time of execution of the transaction process; comparing the priority of the transaction process input from the first application with a priority of a transaction process instructed from a second application if the transaction process instructed from the second application different from the first application is being executed or suspended; judging a database resource conflict between the transaction process instructed from the first application and the transaction processes being executed or suspended if the priority of the transaction process instructed from the first application is higher than the transaction process instructed from the second application as a result of the comparison; determining a transaction process to be suspended or terminated based on a type and a value of a database resource acquired by the transaction processes being executed or suspended and a type and a value of a database resource to be acquired by the transaction process instructed from the first application; executing the transaction process instructed from the first application by acquiring a value described in the database resource acquisition schedule information for the type of the database resource included in the database resource acquisition schedule information after suspension or termination of the transaction process to be suspended or terminated is completed; and restarting the execution of the suspended transaction process after the execution of the transaction process instructed from the first application is completed. The steps are carried out by the database management system.

The above and other problems and solutions thereto disclosed herein will become more apparent from the following description of the preferred embodiments of the present invention with reference to the accompanying drawings.

According to the present invention, data loss may be prevented when a prioritized transaction process is generated.

### BRIEF DESCRIPTION OF THE DRAWINGS

FIG. 1 is a diagram of a schematic of a transaction parallel control method;

FIG. 2 is a diagram of an example of an information processing apparatus 226 where transaction parallel control is executed;

FIG. 3 is an explanatory flowchart of a transaction parallel control process;

FIG. 4 is a diagram of an example of database configuration information;

FIG. 5 is an explanatory flowchart of a database establishing process;

FIG. 6 is a diagram of an example of a transaction process queue list;

FIG. 7 is a diagram of an example of database resource acquisition schedule information;

FIG. 8A is a diagram of an example of available memory area information;

FIG. 8B is a diagram of another example of the available memory area information;

FIG. 9 is an explanatory flowchart of a transaction process request accepting process;

FIG. 10 is a diagram of an example of transaction state management information;

FIG. 11 is an example of transaction profile information;

FIG. 12 is an explanatory flowchart of a database resource conflict control process;

FIG. 13A is an explanatory flowchart of a database task control process;

FIG. 13B is an explanatory flowchart of the database task control process;

FIG. 13C is an explanatory flowchart of the database task control process;

FIG. 13D is an explanatory flowchart of the database task control process;

FIG. 13E is an explanatory flowchart of the database task control process;

FIG. 13F is an explanatory flowchart of the database task control process;

FIG. 13G is an explanatory flowchart of the database task control process;

FIG. 14A is an explanatory flowchart of a database task process;

FIG. 14B is an explanatory flowchart of the database task process;

FIG. 14C is an explanatory flowchart of the database task process;

FIG. 15 is an explanatory flowchart of a shared lock conflict control process;

FIG. 16 is an explanatory flowchart of an exclusive lock conflict control process;

FIG. 17 is an explanatory flowchart of a database cache memory conflict control process; and

FIG. 18 is an explanatory flowchart of an I/O device conflict control process.

### DETAILED DESCRIPTION OF THE EMBODIMENTS

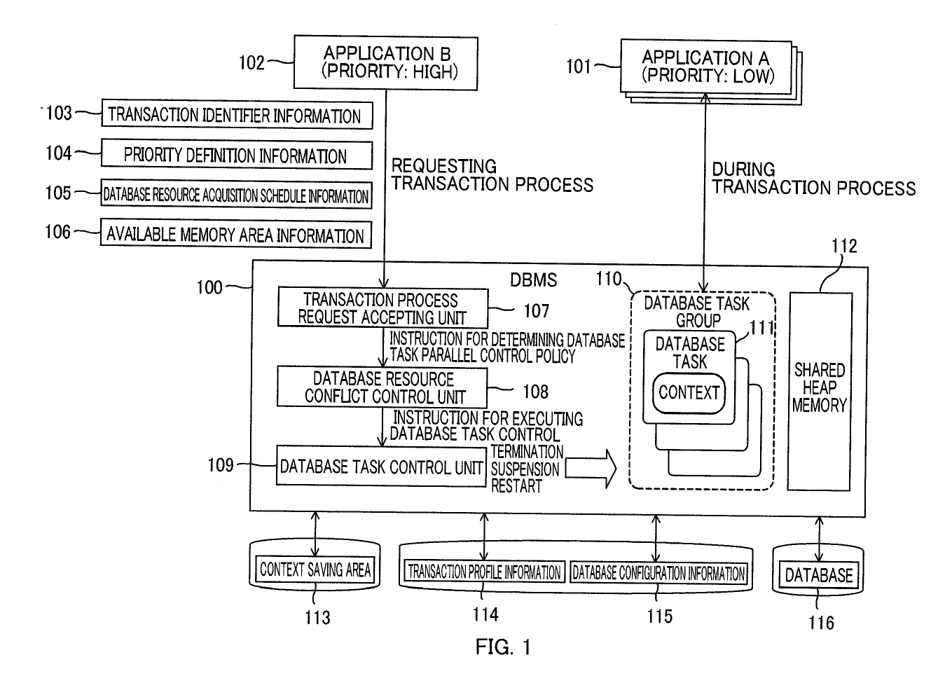

Exemplary embodiments of the present invention will now be described with reference to the accompanying drawings. FIG. 1 is an explanatory diagram of a schematic of a transaction parallel control method described as an embodiment. As shown in FIG. 1, a transaction process request accepting unit 107 of DBMS 100 accepts a transaction process request that is a request for starting a transaction process to the DBMS 100 from an application 102 (first application). The transaction process request is executed through an interface for commands and functions for starting a transaction process provided by the DBMS 100, for example.

The transaction process request accepting unit 107 accepts transaction identifier information 103, priority definition information 104, database resource acquisition schedule information 105, and available memory area information 106 along with the transaction process request. The transaction identifier information 103 is information uniquely identifying a transaction process requested by the application 102 within the DBMS 100. The priority definition information 104 is information describing a priority of a transaction process requested by the application 102. The database resource acquisition schedule information 105 is information describing a type and a value (necessary amount) of a database resource acquired while executing a transaction process requested by the application 102. The available memory area information 106 is information describing a start address and a size of a series of memory areas in a shared heap memory 112 usable for executing a transaction process requested by the application 102.

When receiving the transaction process request, if a transaction process requested by another application 101 (second application) is being executed or suspended, the DBMS 100 compares a priority of the transaction process requested by the application 102 described in the accepted priority definition information 104 with a priority of the transaction process requested by the application 101. As a result of the comparison, if the priority of the transaction process requested by the application 102 is higher, a database resource conflict control unit 108 of the DBMS 100 judges a database resource conflict between the transaction process requested by the application 102 and the transaction processes being executed and suspended in the DBMS 100 based on types and values of database resources acquired by transaction processes being executed and suspended and a type and a value of a database resource to be acquired at the time of execution of the transaction process requested by the application 102 to determine the transaction processes to be suspended and terminated.

The database resource conflict represents that a plurality of different transaction processes of the DBMS 100 requests acquisition of the same database resource, i.e., a state that one transaction process acquires a database resource and, therefore, another transaction process is unable to acquire the database resource.

A database task control unit 109 of FIG. 1 instructs a database task 111 to suspend and terminate a transaction process. The database task 111 completes the suspension and termination of the specified transaction process. If the database task 111 available for allocation of a transaction process exists, the database task control unit 109 starts executing the transaction process requested by the application 102. If none of the database tasks 111 is available for allocation of a transaction process, the database task control unit 109 checks whether the available memory area information 106 includes description related to a memory area within the shared heap memory 112. If the description is included, the database task control unit 109 temporarily generates a database task in the described memory area and the generated database task starts executing the transaction process requested by the application 102. If the description is not included, the database task control unit 109 saves into a context saving area 113 a context 117 consisting of register information, runtime stack information, and global variable area information of the database task 111 allocated to the transaction process being suspended. After the completion of the saving, the database task 111 starts executing the transaction process requested by the application 102. After the completion of the execution of the transaction process requested by the application 102, the database task 111 resumes the execution of the transaction process being suspended.

The above database resources are resources of typical information processing apparatuses (computers), such as memory areas, programs, and hardware devices used by the DBMS for the purpose of executing the transaction processes and, more specifically, a database cache memory that is a memory area for the DBMS 100 temporarily storing data during the transaction process, exclusion of database objects in a database 116 for which locks necessary for parallel execution of a plurality of transaction processes in the DBMS 100 (shared lock and exclusive lock) are acquired, and an I/O device use right for writing/reading data to/from an I/O device where the database 116 exists.

The database objects are constituent elements of the database 116 such as tables generated in the database 116 and rows making up the tables. The exclusion of the database objects is a right (use right) for exclusively using the database objects in the transaction process and includes two types of exclusion, i.e., the shared lock and the exclusive lock. The exclusion, the shared lock, and the exclusive lock are the same as those of typical DBMS.

A total amount of sizes of the database cache memories available to the DBMS 100 is preliminarily determined at the start of the DBMS 100 (e.g., if a total amount of sizes of the database cache memories available to the DBMS 100 is determined as 2 Mbytes, a total value of sizes of the database cache memories acquired by the transaction processes being executed and suspended in the DBMS 100 does not exceed 2 Mbytes).

The I/O device use right is a right necessary for using the I/O device to write and read data.

In the DBMS 100, a state of a transaction process being executed indicates that the query processes included in the transaction process are sequentially executed. The transaction process being executed has acquired the database resources.

In the DBMS 100, a state of a transaction process being suspended indicates that the sequential execution of the query processes included in the transaction process is temporarily stopped. The transaction process being suspended remains in a state of acquiring a portion of the database resources and other database resources are released. The database resources still acquired by the transaction process being suspended include the database cache memory, the exclusion of database objects, etc. An example of the database resources released by the transaction process being suspended includes the I/O device.

In the transaction process being suspended, the sequential execution of the query processes is stopped until restart. The restart of the transaction process indicates that the sequential execution of the query processes included in the transaction process being suspended is directly started from the state of the transaction process when suspended.

The termination of the transaction process indicates returning to a state that none of the query processes included in the transaction process is executed. The termination of the transaction process is the same as the rollback of the transaction in typical DBMS.

Transaction profile information 114 of FIG. 1 is information describing contents of the transaction process requested by the application 102. The contents of the transaction process include a name of a table accessed during the transaction process, a name of a database object for which the shared lock or the exclusive lock is acquired during the transaction process, etc. Database configuration information 115 of FIG. 1 is information describing a database configuration. A configuration of the database 116 includes a name of a storage device having the database 116 generated, names of tables generated in the database, etc.

The transaction profile information 114 and the database configuration information 115 are used for determining database resources scheduled to be acquired during the execution of the transaction process.

A name of a table, a name of a database object, and a name of a storage device enable unique identification of a table, a database object, and a storage device, respectively, in the DBMS 100.

The register information of the database task 111 is a snapshot of a value of a register during the operation of the database task 111. The register is a constituent element of a CPU (Central Processing Unit) included in an information processing apparatus (computer) and is a memory that temporarily stores information representing a result of calculations processed by the CPU and a state of the CPU.

The runtime stack information of the database task 111 is a snapshot of a runtime stack during the operation of the database task 111. The run time stack is a memory area that stores a front/rear relation (order) of function calls during execution of a program, parameters and return values of the function calls, etc.

The global variable area information of the database task 111 is a snapshot of a global variable area during the operation of the database task 111. The global variable area is a memory area that stores a value of a global variable during execution of a program.

The priorities of the transaction processes are values for determining the order of execution of the transaction processes when execution of a plurality of the transaction processes is requested in the DBMS 100 at the same time. Each of the transaction processes always has one priority. The priority values may have any expressive forms or data structures such as numeric values and character strings as long as the priorities may be compared with each other.

A range of priority values of the transaction processes is preliminarily determined in the DBMS 100 (e.g., from 1 to 200). The total number of values available for the priorities of the transaction processes is finite (e.g., 200 integer values from 1 to 200).

The priorities of the transaction processes have the following characteristics:

(a) transaction processes with the same priorities are executed in the order from the process having a transaction process request accepted earlier; and

(b) if a transaction process with a higher priority is requested, switch-over is performed to execute the transaction process with the higher priority even when a transaction process with a lower priority is being executed.

A priority value of a transaction process may be fixed for each application requesting the transaction process or an application may change the priority value based on a state of the application to make a request to the DBMS 100. The DBMS 100 may change the priority value based on the state during the execution of the transaction process. In this case, the priority value of the transaction process may be changed by the DBMS 100 in accordance with instructions from the application requesting the transaction process.

### <System Configuration>

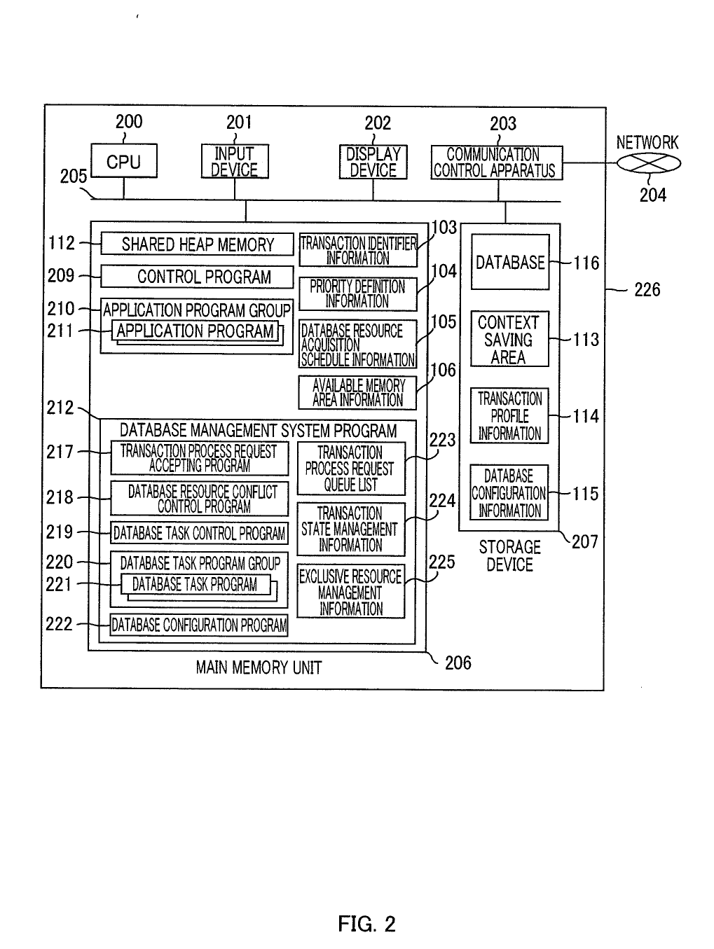

FIG. 2 depicts an example of an information processing apparatus 226 (computer) used in the implementation of the transaction parallel control method of the embodiment. As shown in FIG. 2, the information processing apparatus 226 includes a CPU 200 (CPU: Central Processing Unit), an input device 201, a display device 202, a communication control apparatus 203, a main memory unit 206, a storage device 207, and a system bus 205. Specific examples of the information processing apparatus 226 include portable telephones, car navigation systems, and digital consumer electronics.

The CPU 200 executes programs used in the embodiment. The input device 201 is a device such as a keyboard, a touch pad, and a touch panel and is used for the purpose of inputting commands giving instructions for executing an application program 211 and a database management system program 212. Hardware and a configuration of the input device 201 are not limited. The display device 202 is used for the purpose of displaying the results of execution of the application program 211 and the database management system program 212, for example.

The communication control apparatus 203 is used for the purpose of communication through a network 204. The network 204 may be implemented with any physical network medium such as a wired network and a wireless network, any network configurations such as a star network and a P2P (Peer-to-Peer) network, and any protocols such as SCSI (Small Computer System Interface), Bluetooth, TCP/IP (Transmission Control Protocol/Internet Protocol), CSMA/CD (Carrier Sense Multiple Access with Collision Detection), and GSM (Global System for Mobile Communications) as long as communication through the communication control apparatus 203 may be performed.

The main memory unit 206 stores various programs and temporarily stores data. The storage device 207 is a storage device such as a magnetic disc device and a flash memory device and is used for the purpose of storing the database and information related to the database. Hardware and a configuration of the storage device 207 are not limited.

The main memory unit 206 retains the shared heap memory 112, a control program 209, an application program group 210, a database management system program 212, the transaction identifier information 103, the priority definition information 104, the database resource acquisition schedule information 105, and the available memory area information 106.

The programs used in the embodiment are set in the main memory unit 206 through the communication control apparatus 203 from the network 204.

The shared heap memory 112 is used for the purpose of storing data and programs temporarily necessary at the time of execution of the programs used in the embodiment.

The control program 209 provides a basic function for executing the programs used in the embodiment.

The application program group 210 is a collection of one or more application programs 211. The application programs 211 utilize the functions provided by the database management system program 212 to provide services to users. The application programs 211 input the transaction identifier information 103, the priority definition information 104, the database resource acquisition schedule information 105, and the available memory area information 106 to the database management system program 212 to request the execution of the transaction process.

The database management system program 212 includes a transaction process request accepting program 217, a database resource conflict control program 218, a database task control program 219, a database task program 221, a database configuration program 222, a transaction process request queue list 223, a transaction state management information 224, and an exclusive resource management information 225. The database management system program 212 implements a function of receiving the transaction identifier information 103, the priority definition information 104, the database resource acquisition schedule information 105, and the available memory area information 106 from the application programs 211.

When executed, the database management system program 212 uses the database cache memory, which is a memory area temporarily storing data necessary during the execution of the transaction process, for the purpose of executing the transaction process. A size of the database cache memory available to the database management system program 212 is determined in advance at the start of the process of the database management system program 212. A size of the database cache memory available to the database management system program 212 may be referenced from the database management system program 212.

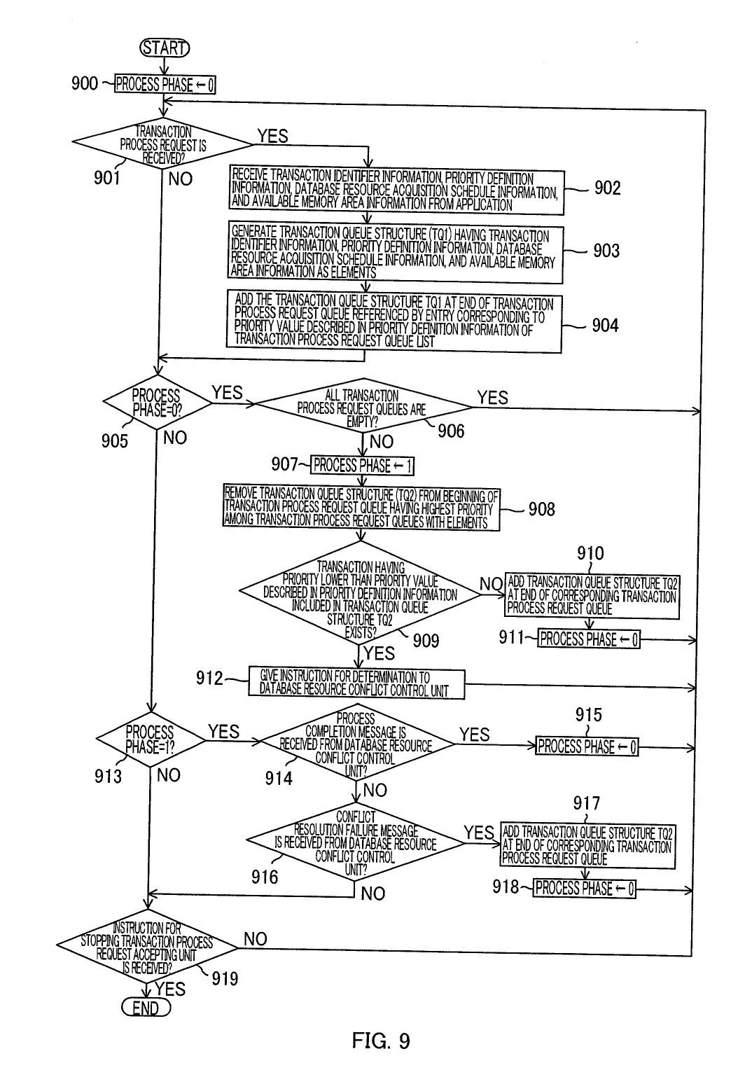

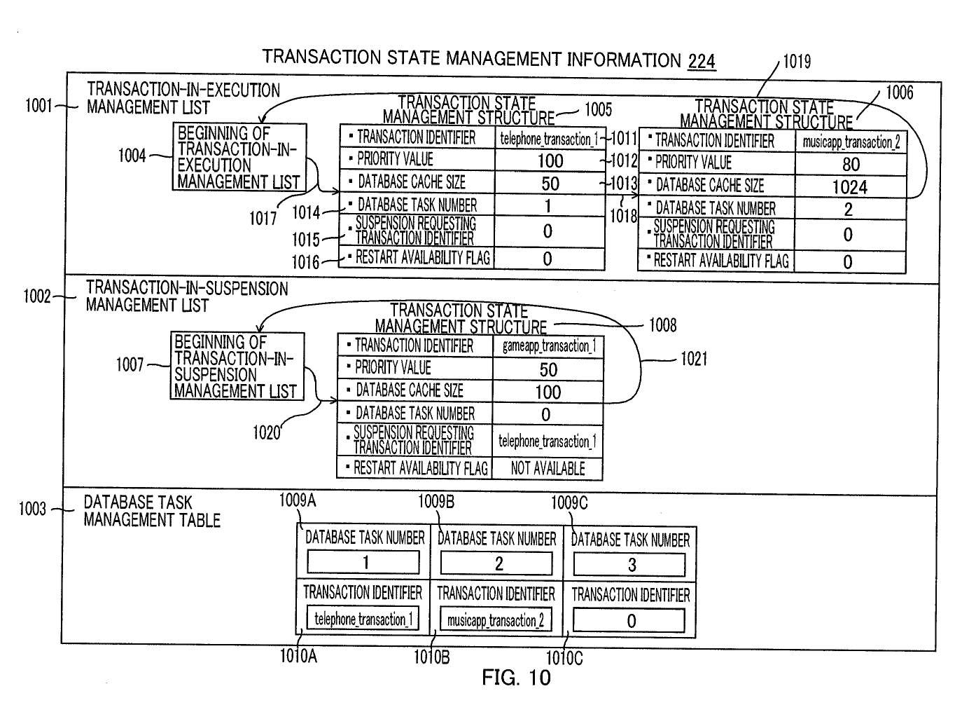

The transaction process request accepting program 217 is a program that implements the transaction process request accepting unit 107 shown in FIG. 1. The transaction process request accepting unit 107 receives the transaction identifier information 103, the priority definition information 104, the database resource acquisition schedule information 105, and the available memory area information 106 input from the application program 211 and instructs the database resource conflict control unit 108 to start the process if the priority described in the priority definition information 104 is higher than the priority of the transaction being executed or suspended by the database management system program 212. Details of the process executed by the transaction process request accepting unit 107 will be described with reference to FIG. 9.

The database resource conflict control program 218 is a program that implements the database resource conflict control unit 108 shown in FIG. 1. The database resource conflict control unit 108 receives the database resource acquisition schedule information 105 from the transaction process request accepting unit 107, refers to the transaction state management information 224, the exclusive resource management information 225, and the database configuration information 115, judges a conflict of database resources between the transaction requested to be processed by the application program 211 and the transactions being executed and suspended, determines transactions to be suspended and terminated, and instructs the database task control unit 109 to start the process.

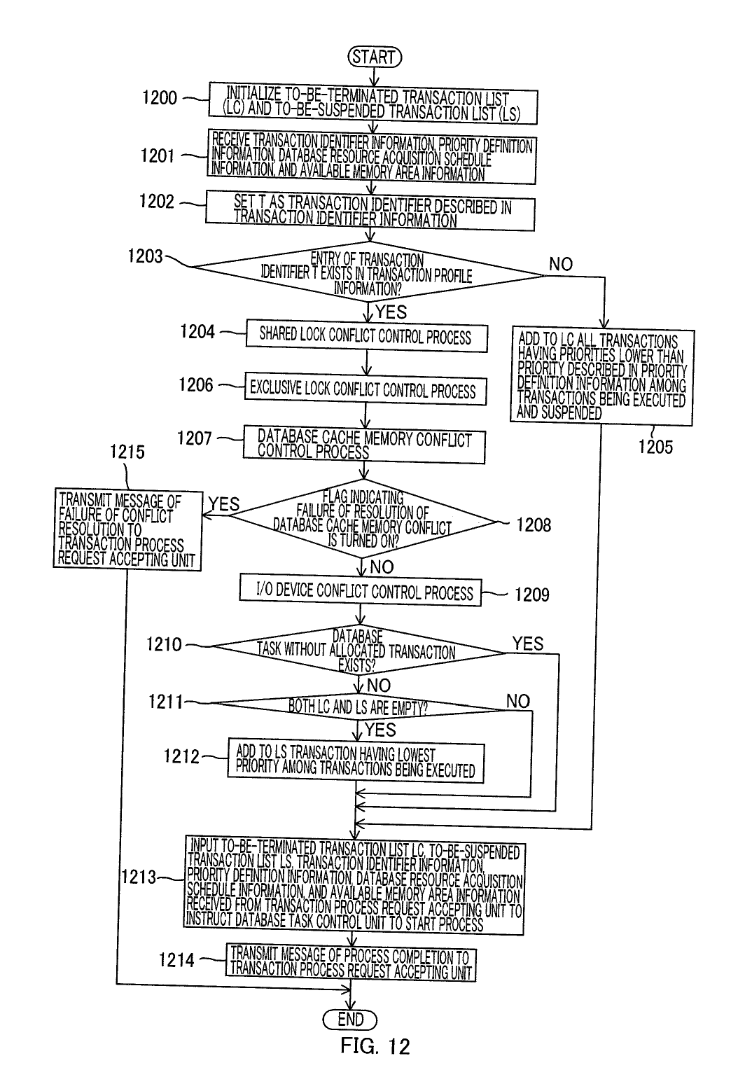

The database resource conflict control unit 108 specifies a transaction to be suspended and a transaction to be terminated for the database task control unit 109 shown in FIG. 1. The database resource conflict control unit 108 inputs the transaction identifier information 103, the priority definition information 104, the database resource acquisition schedule information 105, and the available memory area information 106 to the database task control unit 109. Details of the process executed by the database resource conflict control unit 108 will be described later with reference to FIG. 12.

The database task control program 219 implements the database task control unit 109 shown in FIG. 1. The database task control unit 109 receives the transaction identifier information 103, the priority definition information 104, the database resource acquisition schedule information 105, the available memory area information 106, and the specifications of transaction to be suspended and transaction to be terminated from the database resource conflict control unit 108, instructs the database task 111 to suspend and terminate the specified transactions, and gives instructions for starting the transaction process requested by the application program 211.

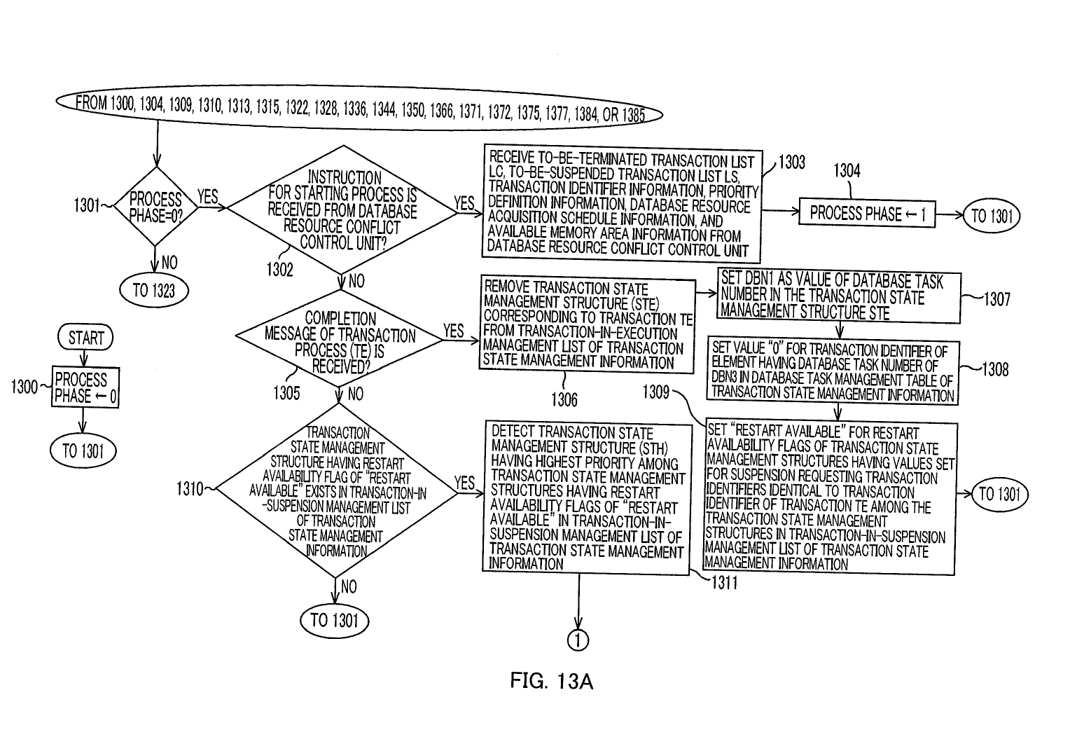

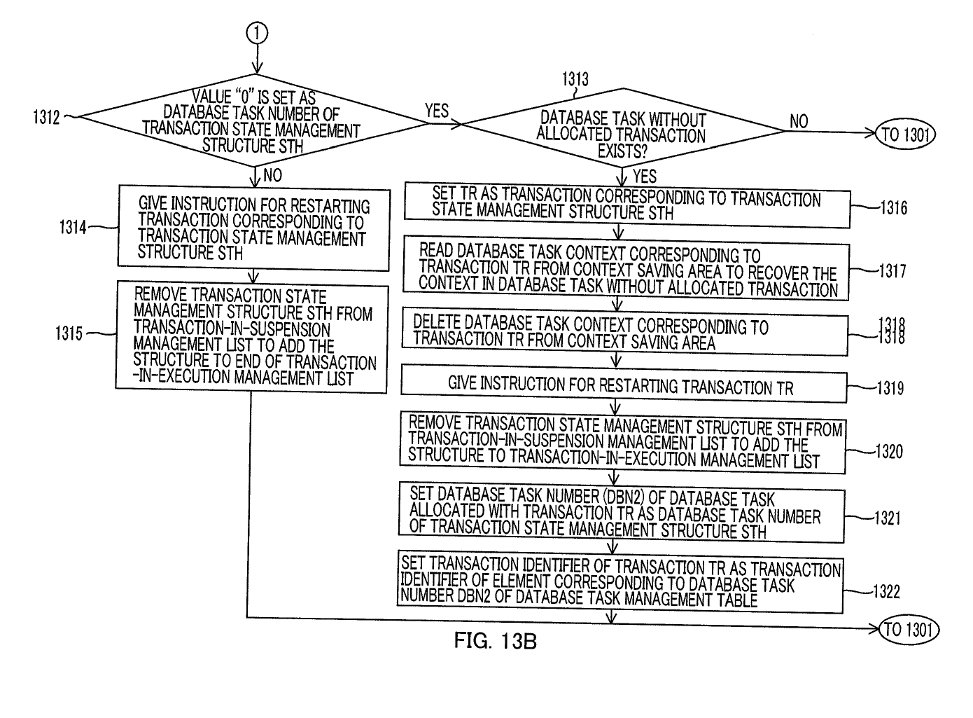

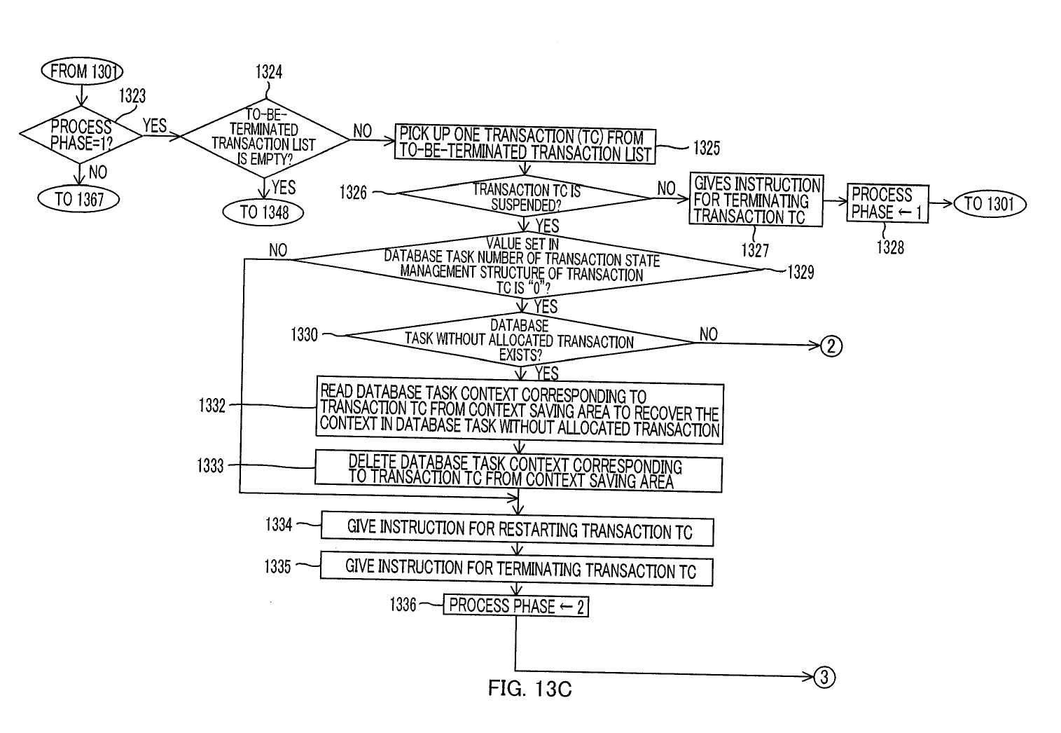

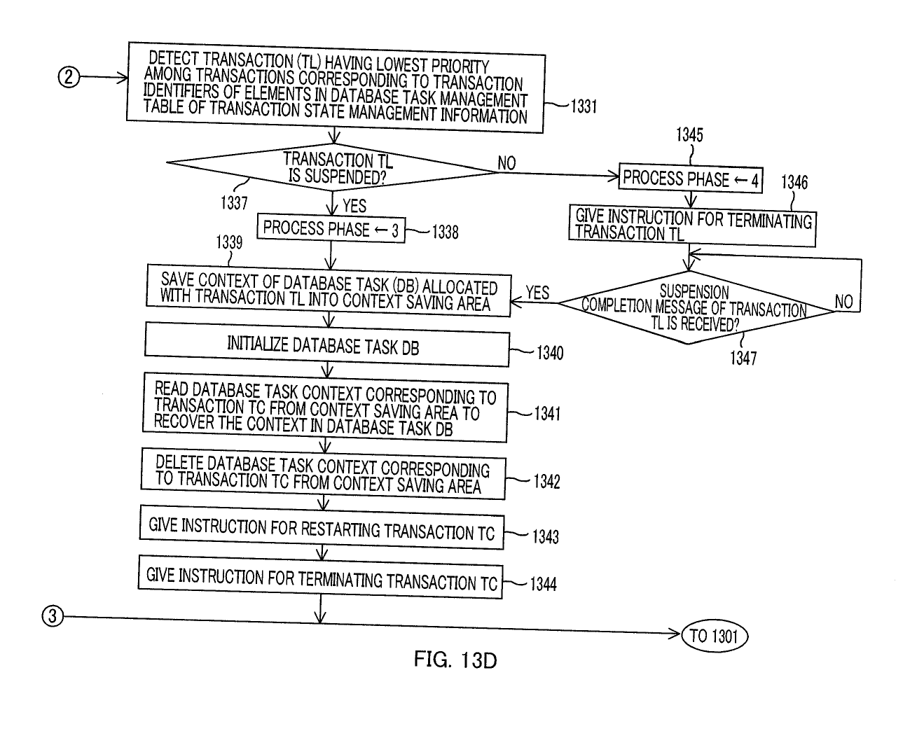

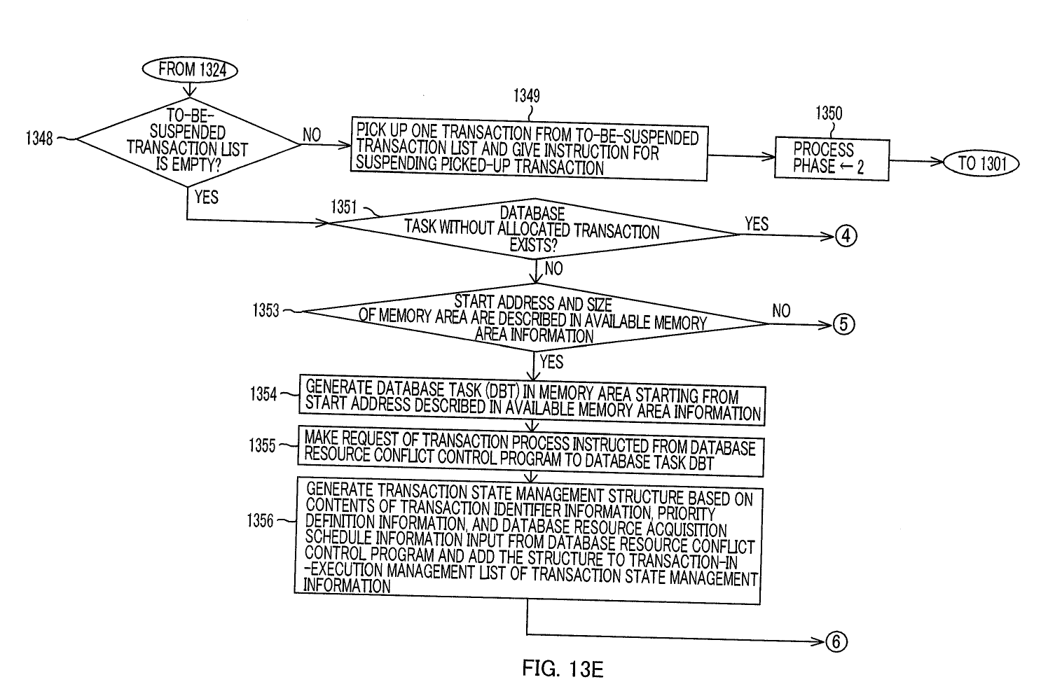

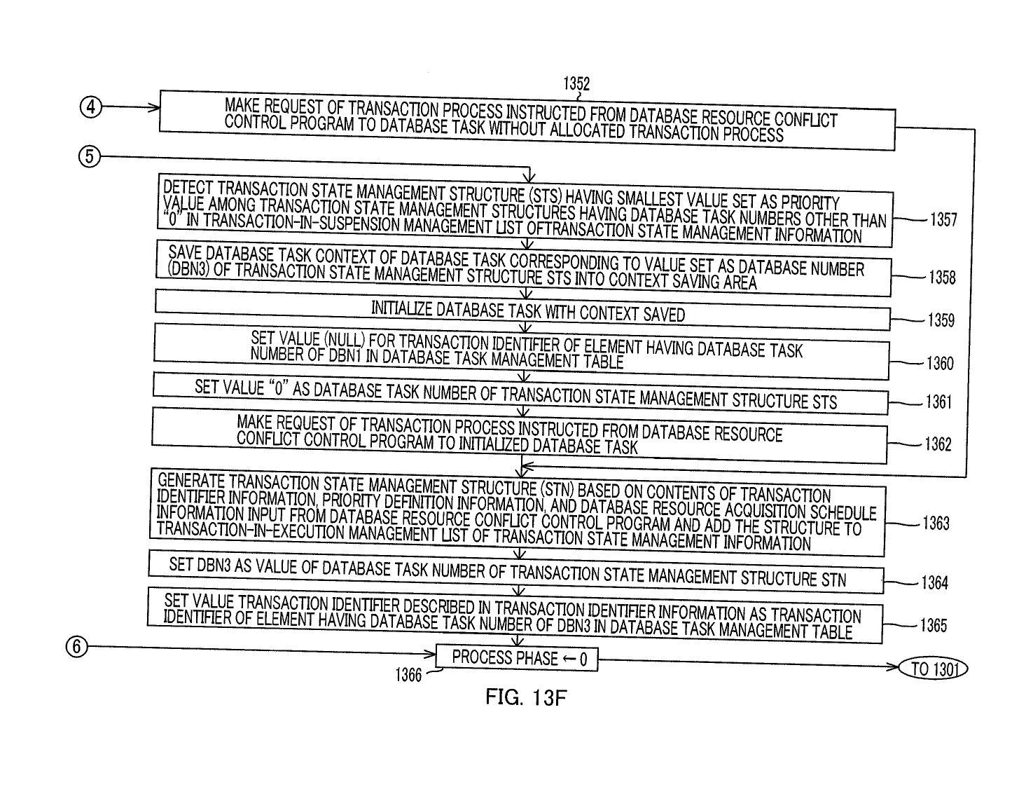

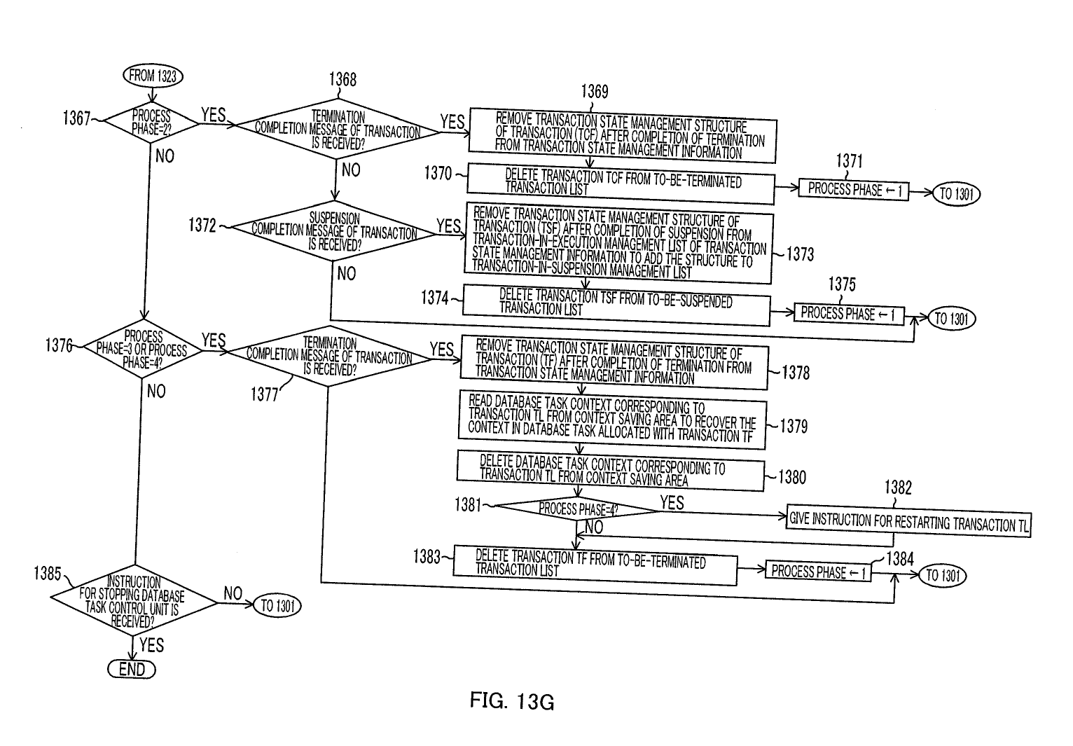

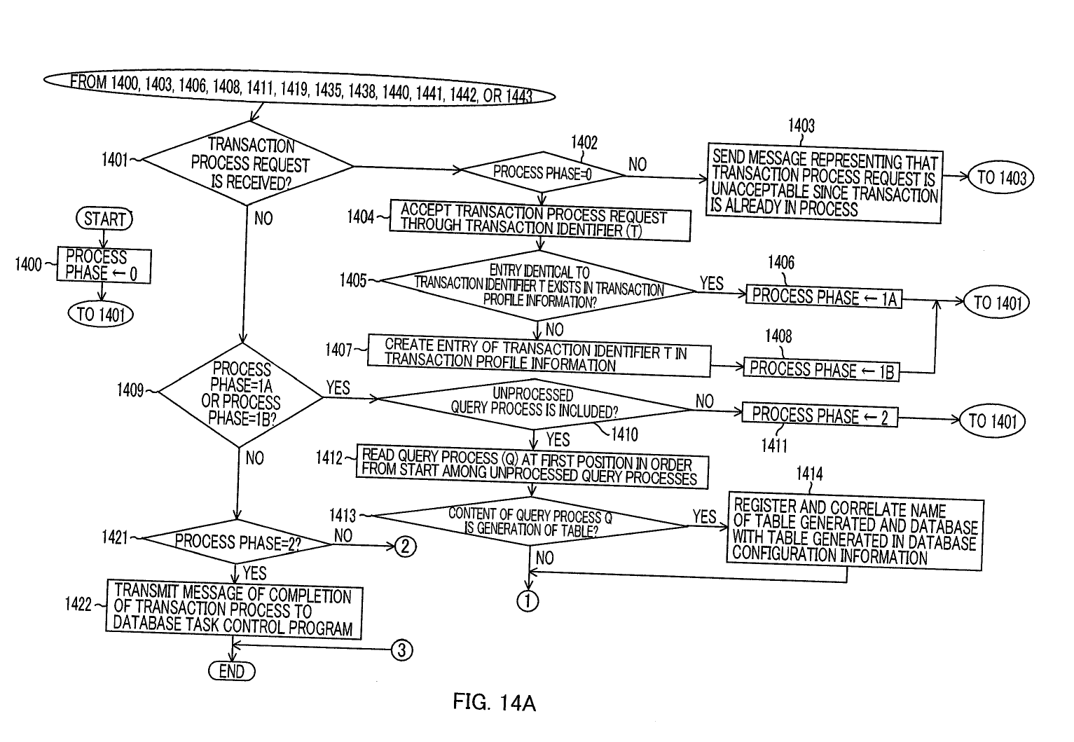

The database task control unit 109 receives a completion message of the transaction process requested by the application program 211 and then gives instructions for restarting the transaction being suspended. Details of the process executed by the database task control unit 109 will be described later with reference to FIGS. 13A, 13B, 13C, 13D, 13E, 13F, and 13G.

A database task program group 220 is a collection of one or more database task programs 221. The number of database task programs 221 included in the database task program group 220 is determined in advance at the start of the process of the database management system program 212. The number of database task programs 221 is determined by a developer, an operator, etc., of the information processing apparatus 226 based on the requirements of the application program group 210, etc.

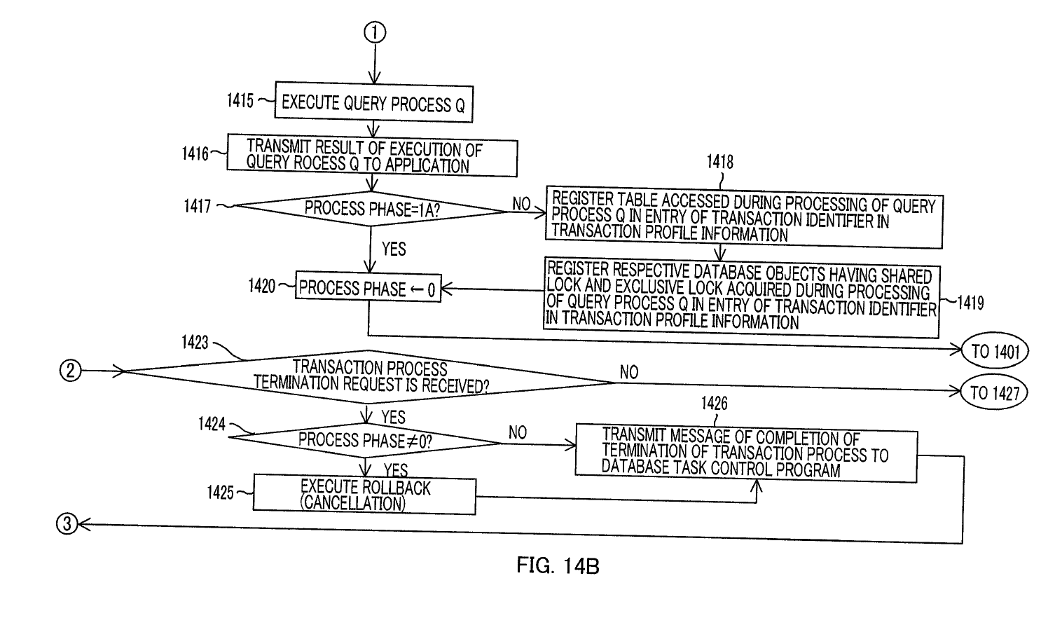

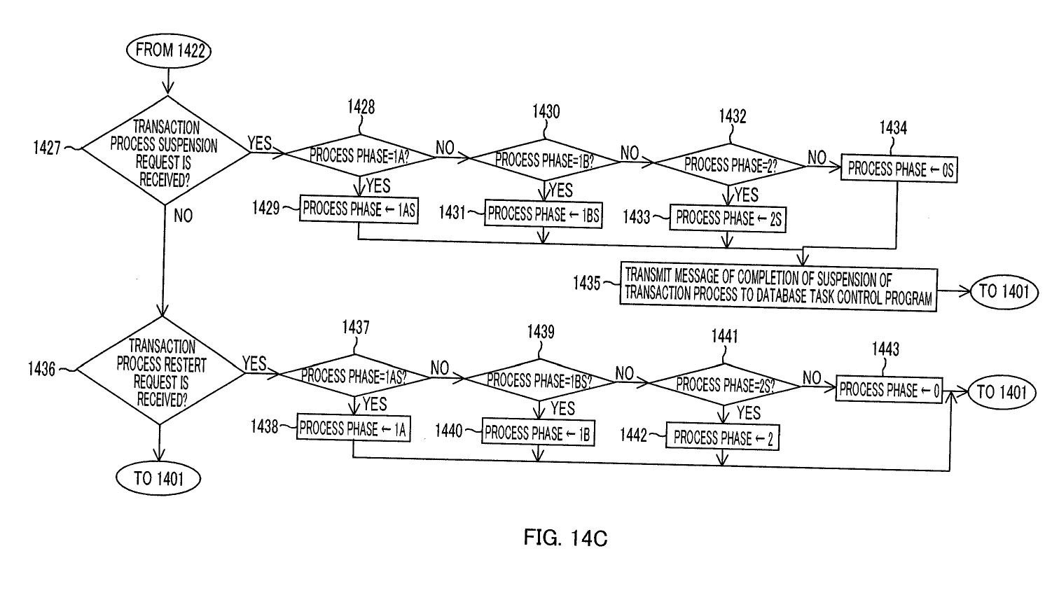

The database task program 221 implements the database task 111 shown in FIG. 1. The database task 111 receives a transaction process request from the database task control unit 109, executes the transaction process, and transmits the execution result to the application program 211. The database task 111 receives a termination request, a suspension request, and a restart request of the transaction process from the database task control unit 109 to perform the termination of the transaction process, the suspension of the transaction process, and the restart of the transaction process, respectively. Details of the process executed by the database task 111 (hereinafter, database task process) will be described later with reference to FIGS. 14A, 14B, and 14C.

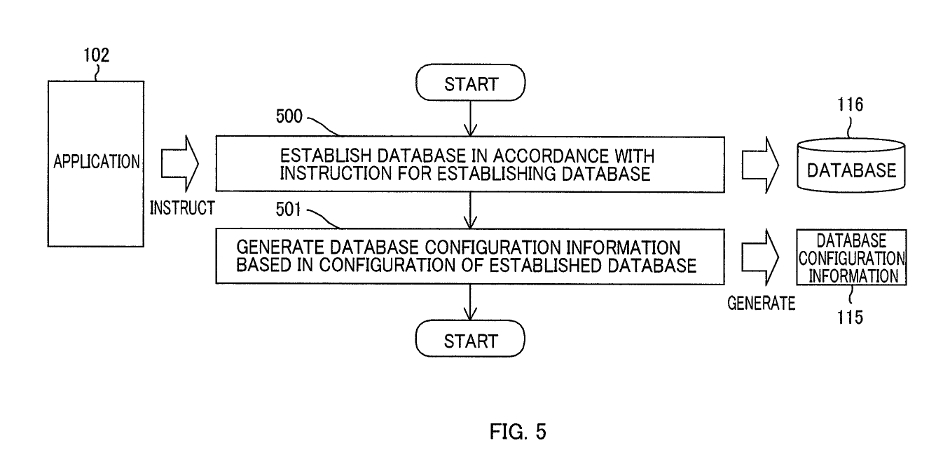

The database configuration program 222 is a program that implements a function of receiving an instruction for establishing a database from the application programs 211 to generate the database 116 and the database configuration information 115 (hereinafter, database establishing unit). Details of this function will be described later with reference to FIG. 5.

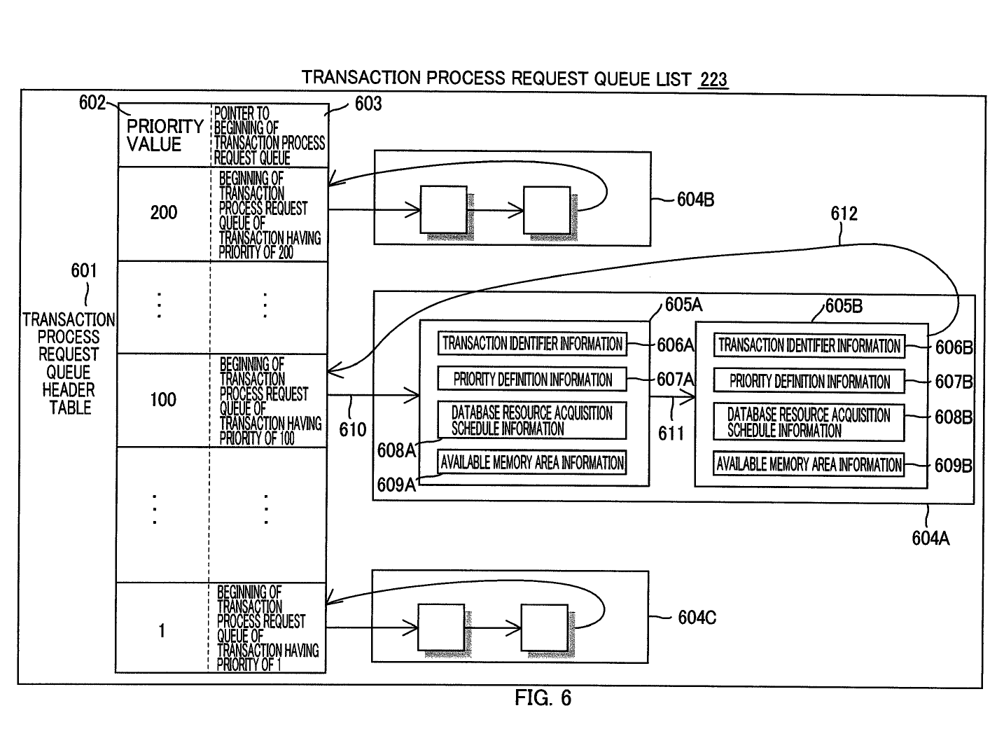

The transaction process request queue list 223 has a data structure that retains transaction process requests from the application programs 211 in the order of arrival of the transaction process requests. An example of the transaction process request queue list 223 of the embodiment will be described later with reference to FIG. 6.

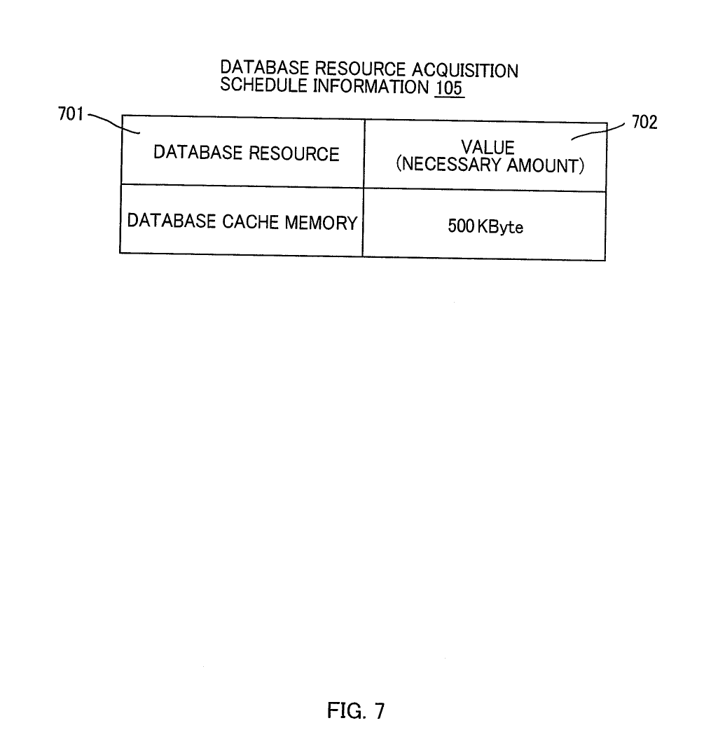

The transaction state management information 224 has a data structure that retains information of a state related to the transactions being executed or suspended in the database management system program 212 and a state related to the database tasks 111. The transaction state management information 224 of the embodiment will be described later with reference to FIG. 7.

The exclusive resource management information 225 has a data structure that retains information related to the transactions acquiring the shared lock or the exclusive lock of the database object in the database 116. The exclusive resource management information 225 is updated by the database task 111 when a transaction process acquires the shared lock or the exclusive lock of the database object and when a transaction process releases the shared lock or the exclusive lock of the database object. The exclusive resource management information 225 has the same as the data structure for the purpose of managing the state of the shared lock or the exclusive lock included in typical DBMS that uses locks to perform the exclusive control.

The transaction identifier information 103 is definition information that describes a transaction identifier for uniquely identifying a transaction and is given from the application program 211 to the database management system program 212.

The priority definition information 104 is definition information that describes a priority of a transaction and is given from the application program 211 to the database management system program 212.

The database resource acquisition schedule information 105 is definition information that describes a type and a value (necessary amount) of a database resource necessary for executing the transaction process and is given from the application program 211 to the database management system program 212. The database resource acquisition schedule information 105 of the embodiment will be described later with reference to FIG. 7.

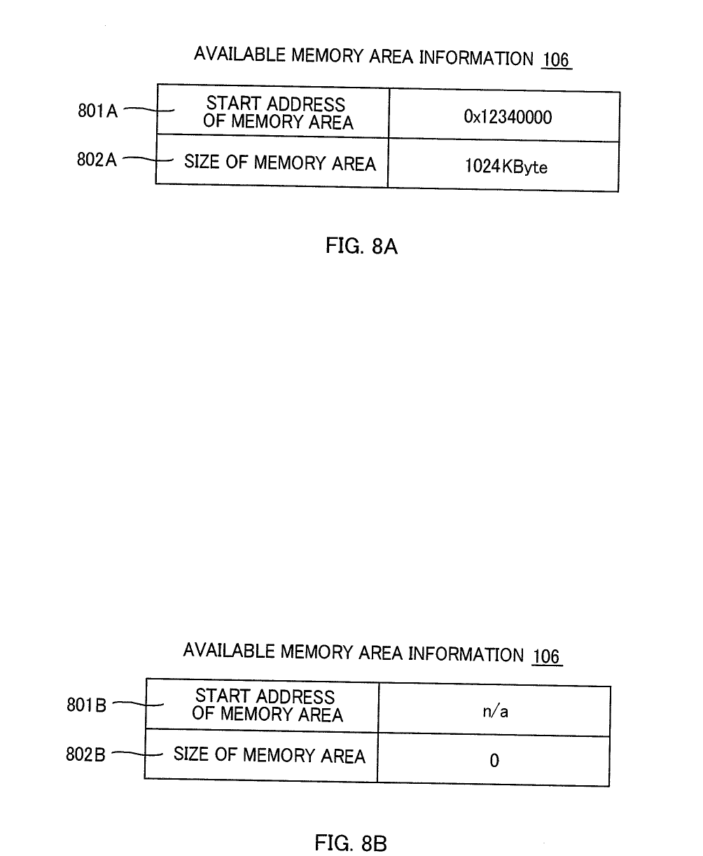

The available memory area information 106 is definition information that describes a start address and a size of a series of memory areas in the shared heap memory 112. The memory area specified by the available memory area information 106 is used for the purpose of temporarily generating the database task 111 by the database task control unit 109 if the transaction process request from the application program 211 is unable to be allocated to the database task 111. The available memory area information 106 of the embodiment will be described later with reference to FIGS. 8A and 8B.

The storage device 207 retains the database 116, the context saving area 113, the transaction profile information 114, and the database configuration information 115.

The database 116 stores the data used by the application program group 210 and the definition information related to the database.

The context saving area 113 is an area for storing a database task context consisting of the register information, the runtime stack information, and the information of the global variable area at the time of execution of the database task program 221 for each transaction. The database task control unit 109 stores the database task context into the context saving area 113, reads the database task context, and deletes the database task context.

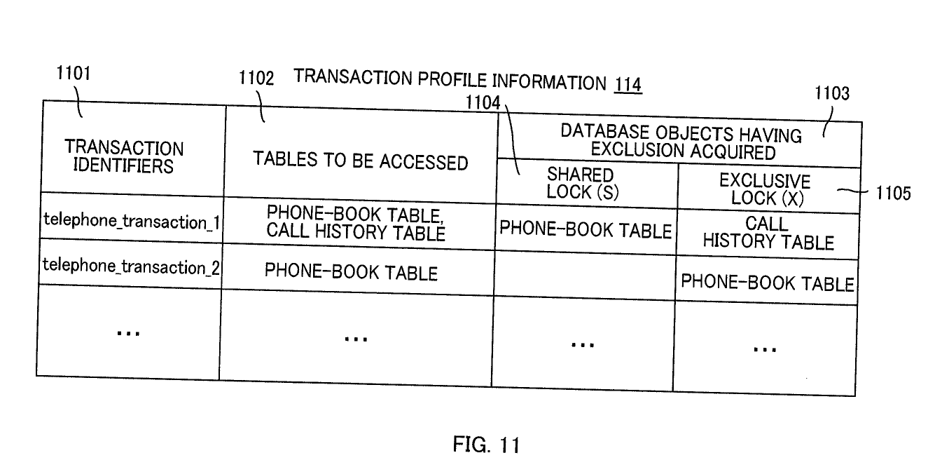

The transaction profile information 114 has a data structure that retains names of tables in the database 116 accessed during the transaction process and names of database objects in the database 116 for which the shared lock and the exclusive lock are acquired during the transaction process for each transaction. The data base task 111 writes information into the transaction profile information 114. The database resource conflict control unit 108 refers to information from the transaction profile information 114. The transaction profile information 114 of the embodiment will be described later with reference to FIG. 11.

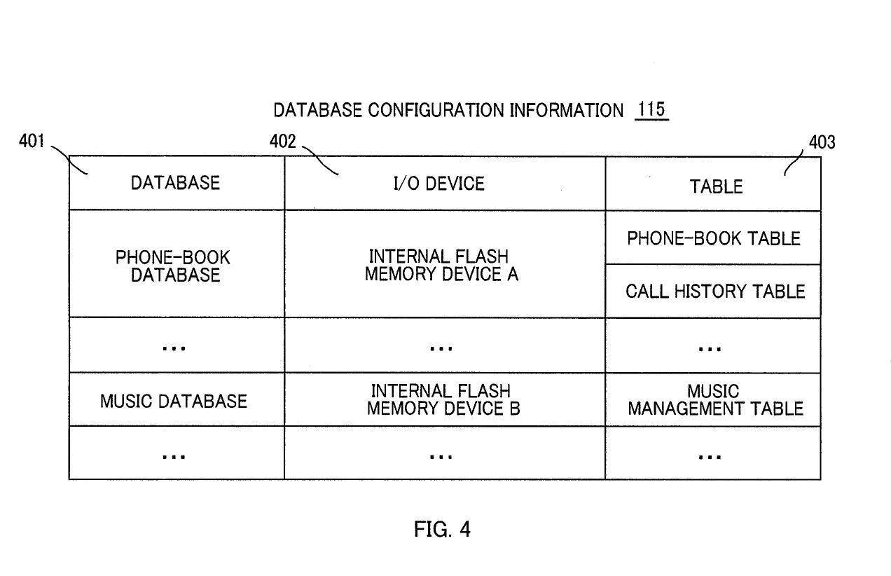

The database configuration information 115 is definition information that describes a name of the storage device 207 having the database 116 generated and names of the tables generated in the database 116. The database configuration information 115 is generated by the database establishing unit and the database task 111. The database configuration information 115 of the embodiment will be described later with reference to FIG. 4.

Although the functions included in the DBMS 100 (the transaction process request accepting unit 107, the database resource conflict control unit 108, the database task control unit 109, etc.) are implemented by the CPU 200 executing the programs as above in this description, these functions may not necessarily be implemented as software and, for example, each of the functions may partially or entirely be implemented as hardware.

### <Transaction Parallel Control Process>

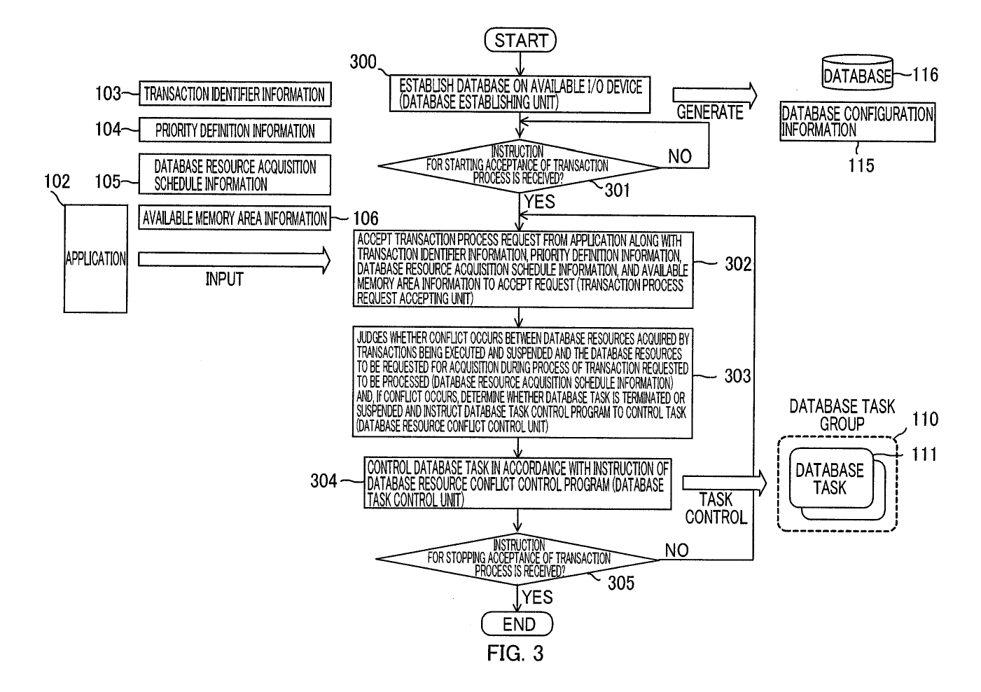

FIG. 3 is an explanatory flowchart of a schematic of a transaction parallel control process. A schematic of the transaction parallel control process will hereinafter be described with reference to FIG. 3.

When receiving an instruction from the application program 211 (step 300), the database establishing unit generates the database 116 in an I/O device available thereto (e.g., the storage device 207) and generates the database configuration information 115. Details of this process will be described later with reference to FIG. 5.

At step 301, it is checked whether the transaction process request accepting unit 107 receives a message giving an instruction for starting the acceptance of the transaction process from the application program 211. If the message is received (YES at step 301), the transaction process request accepting unit 107 accepts a transaction process request from the application program 211 and receives the transaction identifier information 103, the priority definition information 104, the database resource acquisition schedule information 105, and the available memory area information 106 (step 302) and the procedure goes to step 303. If the message is not received (NO at step 301), step 301 is repeatedly performed. Details of the process at S302 (hereinafter, transaction process request accepting process) will be described later with reference to FIG. 9.

At step 303, the database resource conflict control unit 108 judges whether a conflict occurs between the database resources acquired by the transaction processes being executed and suspended in the database management system program 212 and the database resources to be acquired during execution of the transaction of the process request accepted from the application 102. If it is judged that a conflict occurs, it is determined whether the transaction process executed by the database task 111 is terminated or suspended and the database task control unit 109 is instructed to start control of the database task. Details of this process (hereinafter, database resource conflict control process) will be described later with reference to FIG. 12.

At step 304, the database task control unit 109 controls the database task 111. The control of the database task 111 includes start, suspension, termination, and restart of the transaction processes. Details of this process (hereinafter, database task control process) will be described later with reference to FIGS. 13A, 13B, 13C, 13D, 13E, 13F, and 13G.

At step 305, it is checked whether the transaction process request accepting unit 107 receives a message giving an instruction for terminating the acceptance of the transaction process. If the message is received (YES at step 305), the process is terminated. If the message is not received (NO at step 305), the process returns to step 304.

### <Database Configuration Information>

FIG. 4 depicts an example of the database configuration information of the embodiment. The database configuration information 115 is information describing names of the storage devices 207 having the databases 116 generated and names of tables generated in the databases 116.

The database configuration information 115 of FIG. 4 includes fields (401) describing names of the databases 116 managed by the database management system program 212, fields (402) describing names of the I/O devices having the databases generated, and fields (403) describing names of the tables generated in the databases.

The fields (401) describing names of the databases 116 describe names of all the databases managed by the database management system program 212 are described. If one database is managed by the database management system program 212, one database name is described and if a plurality of databases is managed by the database management system program 212, all the names of the plurality of databases are described.

The fields (402) describing names of the I/O devices describe names of the I/O devices where the databases described in the fields (401) describing names of the databases 116 are located.

The fields (403) describing names of the tables describe names of all the tables generated in the databases described in the field (401) describing names of the databases 116.

The fields (401) describing names of the databases, the fields (402) describing names of the I/O devices, and the fields (403) describing names of the tables make up a set of three fields for each of the names of the databases described in the fields (401) describing names of the databases.

The names of the I/O devices described in the fields (402) describing names of the I/O devices and the names of the tables described in the fields (403) describing names of the tables are correlated with the names of the databases described in the fields (401) describing names of the databases such that the correlated database names may be determined.

The database configuration information 115 is generated by the database configuration program 222. In the fields (401) describing names of the databases and the fields (402) describing names of the I/O devices of the database configuration information 115, the information is described by the database configuration program 222. In the fields (401) describing names of the databases of the database configuration information 115, the information is described by the database task program 221.

For example, in the database configuration information shown in FIG. 4, the following information is described. The databases managed by the database management system program 212 include two databases, which are “phone-book database” and “music database”. The “phone-book database” is generated in the I/O device having a name of “internal flash memory device A” and the “music database” is generated in the I/O device having a name of “internal flash memory device B”. The “phone-book database” includes two tables, which are “phone-book table” and “call history table”. The “music database” includes “music management table”.

FIG. 4 depicts minimum information necessary for describing the embodiment. The database configuration information 115 may includes other pieces of information and may be represented in other forms of information if the information of the storage devices with databases generated and the information of the tables generated in the databases may be described. The database configuration information 115 shown in FIG. 4 may interactively be generated with the use of the input device 201 and the display device 202 through the application program group 210.

### <Database Establishing Process>

FIG. 5 is an explanatory flowchart of the details of the database establishing process described in FIG. 3. The details of the database establishing process will hereinafter be described with reference to FIG. 5.

When receiving an instruction from an application, the database establishing unit establishes the database 116 in an I/O device available thereto (e.g., the storage device 207) (step 500). The establishment of the database means that an area for the database is ensured in the I/O device to generate definition information related to the database 116 in the area for the database such that the application program 211 may operate with the use of the database 116.

The database establishing unit then generates the database configuration information 115 based on information related to the configuration of the established database (step 501).

### <Transaction Process Request Queue List>

FIG. 6 depicts an example of the transaction process request queue list 223. The transaction process request queue list 223 has a data structure that retains transaction process requests from the application programs 211 in the order of arrival of the transaction process requests.

The transaction process request queue list 223 shown in FIG. 6 consists of a transaction process request queue header table (601) and transaction process request queues (604A, 604B, and 604C).

The transaction process request queue header table (601) is an array of data structures consisting of sets of two fields, i.e., a field (602) describing a priority value and a field (603) registering a pointer to the beginning of the transaction process request queue (604A, 604B, and 604C).

The transaction process request queue header table (601) has the same number of array elements as a total number of values available for the priorities of the transaction processes handled by the database management system program 212. In the transaction process request queue header table (601), respective priority values are registered in the fields (602) describing priority values of respective array elements.

In the fields (603) registering pointers to the beginnings of the transaction process request queues, the pointers are registered for the beginnings of the transaction process request queues (604A, 604B, and 604C) of the transaction processes having the priority values registered in the fields (602) describing priority values corresponding to the array elements of the transaction process request queue header table (601).

The transaction process request queue consists of transaction queue structures (605A, 605B), a pointer (610) from the field (603) registering the pointer to the beginning of the transaction process request queue to the transaction queue structure (605A) at the beginning of the transaction process request queue (604A), a pointer (611) between the transaction queue structures (605A and 605B), and a pointer (612) from the transaction queue structure (605B) at the end of the transaction process request queue (604A) to the field (603) registering the pointer to the beginning of the transaction process request queue.

In the transaction process request queue, all the transaction queue structures making up the transaction process request queue are connected by unidirectional pointers such that all the transaction queue structures may be traced from the pointer (610) to the transaction queue structure (605A) at the beginning of the transaction process request queue (604A).

The transaction queue structure connected by the pointer (610) from the field (603) registering the pointer to the beginning of the transaction process request queue is referred to as the beginning transaction queue structure (605A). The transaction queue structure referring through the pointer (612) to the field (603) registering the pointer to the beginning of the transaction process request queue is referred to as the end transaction queue structure (605B).

In the transaction process request queue, a transaction queue structure closer to the beginning transaction queue structure (605A) indicates that a transaction process request arrives earlier from the application program 211, and a transaction queue structure closer to the end transaction queue structure (605B) indicates that a transaction process request arrives later from the application program 211.

The transaction queue structure consists of areas for retaining the transaction identifier information (606A, 606B), areas for retaining the priority definition information (607A, 607B), areas for retaining the database resource acquisition schedule information (608A, 608B), and areas for retaining the available memory area information (609A, 609B).

The areas for retaining the transaction identifier information (606A, 606B) retain the transaction identifier information 103 input from the application program 211 to the database management system program 212.

The areas for retaining the priority definition information (607A, 607B) retain the priority definition information 104 input from the application program 211 to the database management system program 212.

The areas for retaining the database resource acquisition schedule information (608A, 608B) retain the database resource acquisition schedule information 105 input from the application program 211 to the database management system program 212.

The areas for retaining the available memory area information (609A, 609B) retain the available memory area information 106 input from the application program 211 to the database management system program 212.

The transaction process request queue list 223 is operated by the transaction process request accepting unit 107.

For example, the transaction process request queue list shown in FIG. 6 represents the following facts.

The priority values of the transaction processes handled by the database management system program 212 are within a range from “1” to “200”. Two transaction processes having a priority value of “100” have arrived at the database management system program 212 from the application program group 210.

The transaction process request corresponding to the transaction queue structure including transaction identifier information TID1 (606A) has arrived earlier than the transaction process request corresponding to the transaction queue structure (605B) including transaction identifier information TID2 (606B) in the transaction processes having a priority value of “100”.

The transaction process request queue list 223 may include information other than that described in FIG. 6 and may be represented in other forms of information if the transaction process requests from the application program 211 to the database management system program 212 may be retained in the order of arrival for each priority of the transaction processes.

### <Database Resource Acquisition Schedule Information>

FIG. 7 depicts an example of the database resource acquisition schedule information 105. The database resource acquisition schedule information 105 is definition information that describes a type and a value (necessary amount) of a database resource necessary for executing a transaction process.

The database resource acquisition schedule information 105 shown in FIG. 7 consists of a field (701) describing a type of a database resource and a field (702) describing a value (necessary amount) of a database resource.

The field (701) describing a type of a database resource describes a type of a database resource necessary for executing the transaction process. The type of the database resource described in the field (701) describing a type of a database resource includes a database cache memory.

The field (702) describing a value (necessary amount) of a database resource describes a value (necessary amount) for each database resource described in the field (701) describing a type of a database resource.

For example, the database resource acquisition schedule information 105 of FIG. 7 indicates that 500 Kbyte of the database cache memory must be acquired to execute the transaction process requested from the application program 211 to the database management system program 212.

The database resource acquisition schedule information 105 of FIG. 7 may include other pieces of information and may be represented in other forms of information if a type and a value (necessary amount) of a database resource to be acquired for executing a transaction process may be described. The database resource acquisition schedule information 105 is supplied from the application program 211. The database resource acquisition schedule information 105 may interactively be generated with the use of the input device 201 and the display device 202 through the application program group 210.

### <Available Memory Area Information>

FIGS. 8A and 8B depict examples of the available memory area information 106. The available memory area information 106 is definition information describing a start address and a size of a series of memory areas in the shared heap memory 112.

The available memory area information 106 consists of a field (801A, 801B) describing a memory address in the shared heap memory 112 and a field (802A, 802B) describing a size of a memory area in the shared heap memory 112.

The field (801A, 801B) describing a memory address describes the start address of a series of memory areas in the shared heap memory 112. The field (802A, 802B) describing a size of a memory area describes a size of a series of memory areas in the shared heap memory 112.

For example, the available memory area information 106 of FIG. 8A indicates that a series of memory areas of 1024 Kbyte starting from the address of 0X12340000 in the shared heap memory 112 for executing the transaction process requested from the application program 211 to the DBMS 100 (database management system program 212).

The available memory area information 106 of FIG. 8B indicates that a memory are in the shared heap memory 112 cannot be used for executing the transaction process requested from the application program 211 to the DBMS 100 (database management system program 212).

FIGS. 8A and 8B depicts minimum information necessary for describing the embodiment. The available memory area information 106 may includes other pieces of information and may be represented in other forms of information if a start address and a size of a series of memory areas in the shared heap memory 112 may be described. The available memory area information 106 shown in FIGS. 8A and 8B may interactively be generated with the use of the input device 201 and the display device 202 through the applications implemented by the application program group 210.

### <Transaction Process Request Accepting Process>

FIG. 9 is an explanatory flowchart of the details of the transaction process request accepting process (process at step 302) described in FIG. 3.

The transaction process request accepting unit 107 sets “0” for a process phase, which is a variable referenced by the transaction process request accepting program 217 (step 900).

At step 901, the transaction process request accepting unit 107 checks whether a message requesting the execution of the transaction process is received from the application program 211. If the message requesting the execution of the transaction process is received (YES at step 901), the process goes to step 902. If the message requesting the execution of the transaction process is not received (NO at step 901), the process goes to step 905.

At step 902, the transaction process request accepting unit 107 receives the transaction identifier information 103, the priority definition information 104, the database resource acquisition schedule information 105, and the available memory area information 106 from the application program 211.

At step 903, the transaction process request accepting unit 107 generates a transaction queue structure (denoted by TQ1) retaining the transaction identifier information 103, the priority definition information 104, the database resource acquisition schedule information 105, and the available memory area information 106 received from the application program 211.

At step 904, the transaction process request accepting unit 107 adds the transaction queue structure TQ1 at the end of the transaction process request queue corresponding to the priority value described in the priority definition information 104 of the transaction process request queue list 223. After step 904, the process goes to step 905.

At step 905, the transaction process request accepting unit 107 checks whether the process phase of the transaction process request accepting program 217 is “0”. If the “process phase” is “0” (YES at step 905), the process goes to step 906. If the “process phase” is not “0” (NO at step 905), the process goes to step 913.

At step 906, the transaction process request accepting unit 107 checks whether no transaction structure is present in any transaction process request queue of the transaction process request queue list 223 (whether queues are empty). If not present (empty) (YES at step 906), the process goes back to step 901. If present (not empty) (NO at step 906), the process goes back to step 907.

At step 907, the transaction process request accepting unit 107 sets “1” for the process phase of the transaction process request accepting program 217.

At step 908, the transaction process request accepting unit 107 removes one transaction queue structure (denoted by TQ2) from the beginning of the transaction process request queue for the transaction process having the highest priority among the transaction process request queues having one or more transaction queue structures.

At step 909, the transaction process request accepting unit 107 refers to the transaction state management information 224 to check whether the transaction processes being executed in the database management system program 212 include a transaction process having a priority lower than the priority described in the priority definition information retained by the transaction queue structure TQ2. If the transaction process having a lower priority is included (YES at step 909), the process goes to step 912. If the transaction process having a lower priority is not included (NO at step 909), the process goes to step 910.

At step 910, the transaction process request accepting unit 107 adds the transaction queue structure TQ2 at the end of the transaction process request queue corresponding to the priority described in the priority definition information retained by the transaction queue structure TQ2.

At step 911, the transaction process request accepting unit 107 sets “0” for the process phase of the transaction process request accepting program 217 and the process goes back to step 901.

At step 912, the transaction process request accepting unit 107 instructs the database resource conflict control unit 108 to judge a database resource conflict and determine the transaction process to be suspended or terminated and the process goes back to step 901.

At step 913, the transaction process request accepting unit 107 checks whether the process phase of the transaction process request accepting program 217 is “1”. If the process phase is “1” (YES at step 913), the process goes to step 914. If the process phase is not “1” (NO at step 913), the process goes to step 919.

At step 914, the transaction process request accepting unit 107 checks whether a message notifying of the completion of execution of a process is received from the database resource conflict control unit 108. If the message notifying of the completion of execution of a process is received (YES at step 914), the process goes to step 915. If the message notifying of the completion of execution of a process is not received (No at step 914), the process goes to step 916.

At step 915, the transaction process request accepting unit 107 sets “0” for the process phase of the transaction process request accepting program 217 and the process then goes back to step 901.

At step 916, the transaction process request accepting unit 107 checks whether a message notifying of a failure of resolution of the conflict of database resources is received from the database resource conflict control unit 108. If the message notifying of a failure of resolution of the conflict is received (YES at step 916), the process goes to step 917. If the message notifying of a failure of resolution of the conflict is not received (NO at step 916), the process goes to step 919.

At step 917, the transaction process request accepting unit 107 adds the transaction queue structure TQ2 at the end of the transaction process request queue corresponding to the priority described in the priority definition information retained by the transaction queue structure TQ2.

At step 918, the transaction process request accepting unit 107sets “0” for the process phase of the transaction process request accepting program 217 and the process goes back to step 901.

At step 919, the transaction process request accepting unit 107 checks whether an instruction for stopping the process of the transaction process request accepting program 217 is received. If the instruction for stopping the process is received (YES at step 919), the process of the transaction process request accepting program 217 is terminated. If the instruction for stopping the process is not received (NO at step 919), the process goes back to step 901.

In the above description, adding a transaction queue structure at the end of a transaction process request queue means the following facts. The pointer to the transaction process request queue header table is removed from the transaction queue structure at the end of the transaction process request queue before adding the transaction queue structure; a pointer to the newly added transaction queue structure is generated from the transaction queue structure at the end of the transaction process request queue before adding the transaction queue structure; and a pointer to the field 603 of the transaction process request queue header table is generated from the newly added transaction queue structure.

Removing the transaction queue structure TQ2 from the beginning of the transaction process request queue means the following facts. Assuming that TQN denotes a transaction queue structure referenced by the pointer from the beginning transaction queue structure, a pointer to the transaction queue structure TQ2 is deleted from the field 603 of the transaction process request queue header table; a pointer to the transaction queue structure TQN is deleted from the transaction queue structure TQ2; and a pointer to the transaction queue structure TQN is generated from the field 603 of the transaction process request queue header table.

### <Transaction State Management Information>

FIG. 10 depicts an example of the transaction state management information 224. The transaction state management information 224 includes information representing a state of transactions being executed and suspended and a data structure that retains information representing a state of the database tasks 111.

The transaction state management information 224 shown in FIG. 10 consists of a transaction-in-execution management list (1001), a transaction-in-suspension management list (1002), and a database task management table (1003).

The transaction-in-execution management list (1001) has a data structure that retains information related to a state of transaction processes being executed in the database management system program 212.

The transaction-in-execution management list (1001) consists of an area (1004) for retaining a pointer referring to the beginning of the transaction-in-execution management list, transaction state management structures (1005, 1006), a pointer (1017) to the transaction state management structure from the area (1004) for retaining a pointer referring to the beginning of the transaction-in-execution management list, a pointer (1018) between the transaction state management structures (1005, 1006), and a pointer (1019) from the transaction state management structure to the area (1004) for retaining a pointer referring to the beginning of the transaction-in-execution management list.

In the transaction-in-execution management list (1001), all the transaction state management structures making up the transaction-in-execution management list are connected by unidirectional pointers such that all the transaction state management structures may be traced from the pointer (1017) referring to the beginning of the transaction-in-execution management list.

The transaction-in-suspension management list (1002) has a data structure that retains information related to a state of transaction processes being suspended in the database management system program 212.

The transaction-in-suspension management list (1002) consists of an area (1007) for retaining a pointer referring to the beginning of the transaction-in-suspension management list, transaction state management structures (1008), a pointer (1020) to the transaction state management structure from the area (1007) for retaining a pointer referring to the beginning of the transaction-in-suspension management list, a pointer between the transaction state management structures, and a pointer (1021) from the transaction state management structure to the area (1007) for retaining a pointer referring to the beginning of the transaction-in-suspension management list.

In the transaction-in-suspension management list (1002), all the transaction state management structures making up the transaction-in-suspension management list are connected by unidirectional pointers such that all the transaction state management structures may be traced from the pointer (1020) referring to the beginning of the transaction-in-suspension management list.

The transaction state management structure (1005, 1006, 1008) consists of a field loll registering a transaction identifier, a field 1012 registering a priority value, a field 1013 registering a database cache size, a field 1014 registering a database task number, a field 1015 registering a suspension requesting transaction identifier, and a field 1016 registering a restart availability flag.

The field (1011) registering a transaction identifier accepts registration of a transaction identifier of a transaction process being executed or suspended is registered.

The field (1012) registering a priority value accepts registration of a priority value of the transaction process having the transaction identifier registered in the field (1011) registering a transaction identifier.

The field (1013) registering a database cache size accepts registration of a size of a database cache memory acquired by the transaction process having the transaction identifier registered in the field (1011) registering a transaction identifier.

The field (1014) registering a database task number accepts registration of a database task number of the database task allocated with the transaction process having the transaction identifier registered in the field (1011) registering a transaction identifier.

If “0” is registered in the field (1014) registering a database task number, this represents that the process is allocated to a database task generated in a series of memory areas in the shared heap memory 112 in the case of the transaction process being executed or that the transaction process is not allocated to any database task in the case of the transaction process being suspended.

The field (1015) registering a suspension requesting transaction identifier accepts registration of a transaction identifier of the transaction process causing the suspension of the transaction process having the transaction identifier registered in the field (1011) registering a transaction identifier. If the transaction process is being executed, “0” is registered.

The field 1016 registering a restart possibility flag accepts registration of a flag representing whether restart of a transaction process being suspended is available (“restart available” of “restart not available”). If the transaction process is being executed, “0” is registered.

The database task management table (1003) is an array of data structures consisting of sets of two fields, i.e., a fields (1009A, 1009B, 1009C) registering database task numbers that are numbers given to database tasks and fields (1010A, 1010B, 1010C) registering transaction identifiers.

The database task management table (1003) has the same number of array elements as the number of the database task programs 221 included in the database task program group 220. Since the number of the database task programs 221 included in the database task program group 220 is determined in advance at the start of the process of the database management system program 212, the number of array elements included in the database task management table (1003) is determined in advance at the start of the process of the database management system program 212.

The fields (1009A, 1009B, 1009C) registering database task numbers accept registration of database task numbers uniquely identifying the database tasks in the database management system program 212. In the database task management table (1003), respective database task numbers are registered in the fields describing the respective database task numbers.

The fields (1010A, 1010B, 1010C) registering transaction identifiers accept registration of transaction identifiers of the transaction processes allocated to the database tasks 111 corresponding to the database task numbers registered in the fields registering database task numbers in the array elements.

The database task numbers are values (character strings and numerical numbers) except “zero” and may have any forms of representation and any data structures as long as the numbers uniquely identify the database tasks in the database management system program 212. The database task numbers corresponding to the database tasks of the database management system program 212 are determined in advance at the start of the process of the database management system program 212.

For example, the transaction state management information 224 of FIG. 10 represents the following facts.

The database task group 110 includes three database tasks 111 represented by database task numbers of “1”, “2”, and “3”. The database task 111 having the database task number of “1” is allocated with a transaction process represented by a transaction identifier of “telephone_transaction_1”; the database task 111 having the database task number of “2” is allocated with a transaction process represented by a transaction identifier of “musicapp_transaction_2”; and the database task 111 having the database task number of “3”, is not allocated with a transaction process.

Two transaction processes are currently being executed. The transaction processes being executed are the transaction process represented by the transaction identifier of “telephone_transaction_1” and transaction process represented by the transaction identifier of “musicapp_transaction_2”.

The transaction process represented by the transaction identifier of “telephone_transaction_1” has a priority value of “100”, has acquired 50 Kbyte of the database cache memory, and is allocated to the database task 111 represented by the database task number of “1”.

The transaction process represented by the transaction identifier of “musicapp_transaction_2” has a priority value of “80”, has acquired 1024 Kbyte of the database cache memory, and is allocated to the database task 111 represented by the database task number of “2”.

One transaction process is currently being suspended. The transaction process being suspended is a transaction process represented by a transaction identifier of “gameapp_transactional_1”.

The transaction process represented by the transaction identifier of “gameapp_transaction_1” has a priority value of “80”, has acquired 50 Kbyte of the database cache memory, and is not allocated to the database task 111. The transaction process represented by the transaction identifier of “gameapp_transaction_1” is suspended due to the transaction process represented by the transaction identifier of “telephone_transaction_1”. The transaction process represented by the transaction identifier of “gameapp_transaction_1” is not in a restartable state.

The transaction state management information 224 of FIG. 10 only indicates minimum information necessary for describing the embodiment. The transaction state management information 224 may includes other pieces of information and may be represented in other forms of information if the information related to the transaction processes being executed and suspended and the information related to the states of the database tasks 111 may be retained.

### <Transaction Profile Information>

FIG. 11 depicts an example of the transaction profile information 114. The transaction profile information 114 of FIG. 11 retains names of tables in the database 116 accessed during a transaction process and names of database objects in the database 116 having the shared lock and the exclusive lock acquired during a transaction process for each transaction.

The transaction profile information 114 of FIG. 11 consists of fields (1101) describing transaction identifiers, fields (1102) describing tables to be accessed at the time of execution of a transaction process, and fields (1103) describing database objects having the exclusion acquired at the time of execution of transaction processes.

The fields (1101) describing transaction identifiers describe transaction identifiers of the transaction processes requested from the database tasks 111 included in the database task group 110.

The fields (1102) describing tables to be accessed describe names of tables to be accessed at the time of execution of the transaction processes corresponding to the transaction identifiers described in the fields (1101) describing transaction identifiers.

The fields (1103) describing database objects having the exclusion acquired consist of fields (1104) describing database objects having the shared lock acquired and fields (1105) describing database objects having the exclusive lock acquired.

The fields (1104) describing database objects having the shared lock acquired describe database objects having the shared lock acquired during the execution of the transaction processes corresponding to the transaction identifiers described in the fields (1101) describing transaction identifiers.

The fields (1105) describing database objects having the exclusive lock acquired describe database objects having the exclusive lock acquired during the execution of the transaction processes corresponding to the transaction identifiers described in the fields (1101) describing transaction identifiers.

The fields (1101) describing transaction identifiers, the fields (1102) describing tables to be accessed at the time of execution of transaction processes, the fields (1104) describing database objects having the shared lock acquired, and the fields (1105) describing database objects having the exclusive lock acquired make up a set of four fields for each of the transaction identifiers described in the fields (1101) describing transaction identifiers.

The names of the tables described in the fields (1102) describing tables to be accessed at the time of execution of transaction processes, the names of the database objects described in the fields (1104) describing database objects having the shared lock acquired, and the names of the database objects described in the fields (1105) describing database objects having the exclusive lock acquired are correlated with the transaction identifiers described in the fields (1101) describing transaction identifiers such that the correlated transaction identifiers may be determined.

The information in the fields of the transaction profile information 114 is described with the database tasks 111.

The transaction profile information of FIG. 11 describes the following facts. The transaction process represented by the transaction identifier of “telephone_transaction_1” accesses a “phone-book table” and a “call history table”, acquires the shared lock for the “phone-book table”, and acquires the exclusive lock for the “call history table” during the execution of the transaction process.

The transaction process represented by the transaction identifier of “telephone_transaction_2” accesses the “phone-book table” and acquires the exclusive lock for the “call history table” during the execution of the transaction process.

Although the transaction profile information of FIG. 11 indicates minimum information necessary for describing the embodiment, other pieces of information may be included. The information may be represented in other forms of information if the information of the tables accessed during the transaction process and the information of the database objects having the shared lock and the exclusive lock acquired during the transaction process may be retained for each transaction.

### <Database Resource Conflict Control Process>

FIG. 12 is an explanatory flowchart of the details of the database resource conflict control process step 303.

At step 1200, the database resource conflict control unit 108 receives a process starting instruction from the transaction process request accepting unit 107 and initializes a to-be-terminated transaction list (denoted by LC) retaining transaction processes to be terminated and a to-be-suspended transaction list (denoted by LS) retaining the transaction processes to be suspended. The LC and the LS are empty sets with the transaction processes defined as elements.

At step 1201, the database resource conflict control unit 108 receives the transaction identifier information 103, the priority definition information 104, the database resource acquisition schedule information 105, and the available memory area information 106 from the transaction process request accepting unit 107.

At step 1202, the database resource conflict control unit 108 sets T as a transaction identifier described in the transaction identifier information 103.

At step 1203, the database resource conflict control unit 108 checks whether the transaction identifier T exists in the fields (1101) describing transaction identifiers of the transaction profile information 114. If the transaction identifier T exists (YES at step 1203), the process goes to step 1204. If the transaction identifier T does not exist (NO at step 1203), the process goes to step 1205.

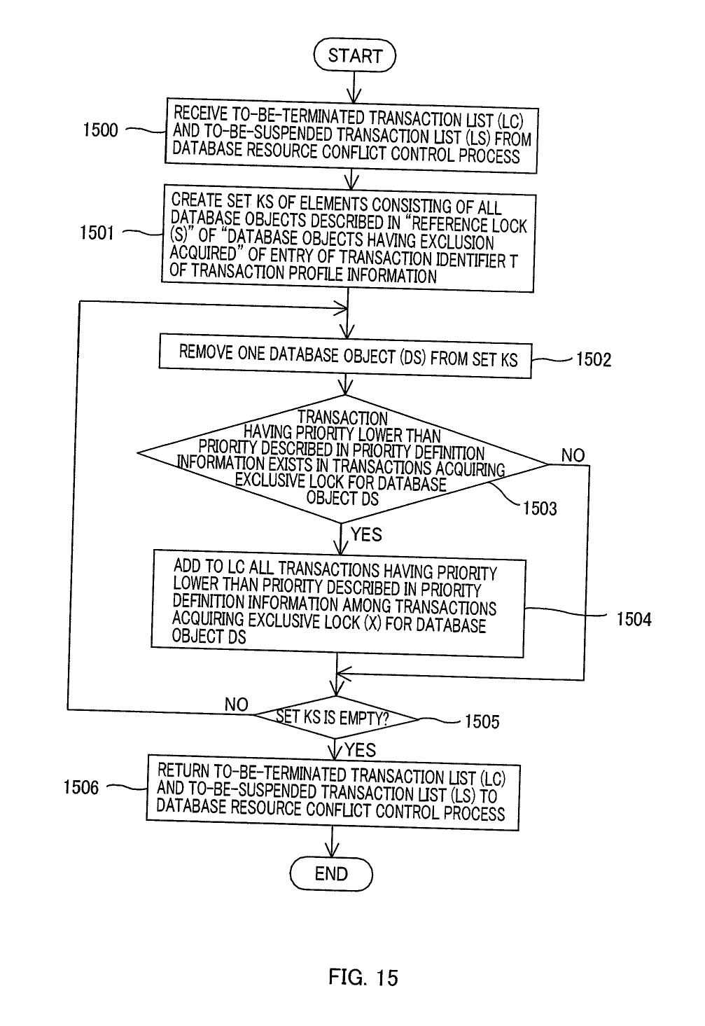

At step 1204, the database resource conflict control unit 108 judges whether a conflict occurs between the shared lock of the database objects to be acquired during execution of the transaction process of the transaction identifier T and the lock of the database objects acquired by the transaction processes being executed and suspended and if the conflict occurs, a determination is made on the transaction processes that must be suspended or terminated to resolve the conflict. Details of this process (hereinafter, a shared lock conflict control process) will be described later with reference to FIG. 15. Subsequently, the process goes to step 1206.

At step 1205, the database resource conflict control unit 108 adds to the LC all the transaction processes corresponding to the transaction identifiers (1011) of the transaction state management structures having the priority values (1012) smaller (the priorities lower) than the priority described in the priority definition information 104 among the transaction state management structures retained by the transaction-in-execution management list (1001) and the transaction-in-suspension management list (1002) of the transaction state management information 224, and the process goes to step 1213.

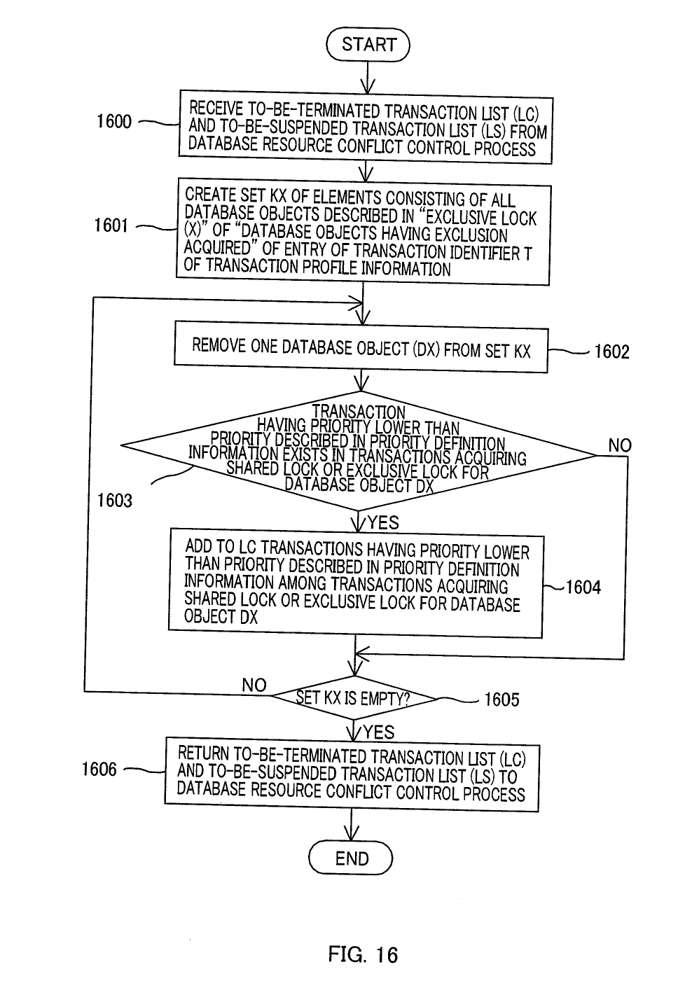

At step 1206, the database resource conflict control unit 108 judges whether a conflict occurs between the exclusive lock of the database objects to be acquired during execution of the transaction process of the transaction identifier T and the lock of the database objects acquired by the transaction processes being executed and suspended and if the conflict occurs, a determination is made on the transaction processes that must be suspended or terminated to resolve the conflict. Details of this process (hereinafter, an exclusive lock conflict control process) will be described later with reference to FIG. 16.

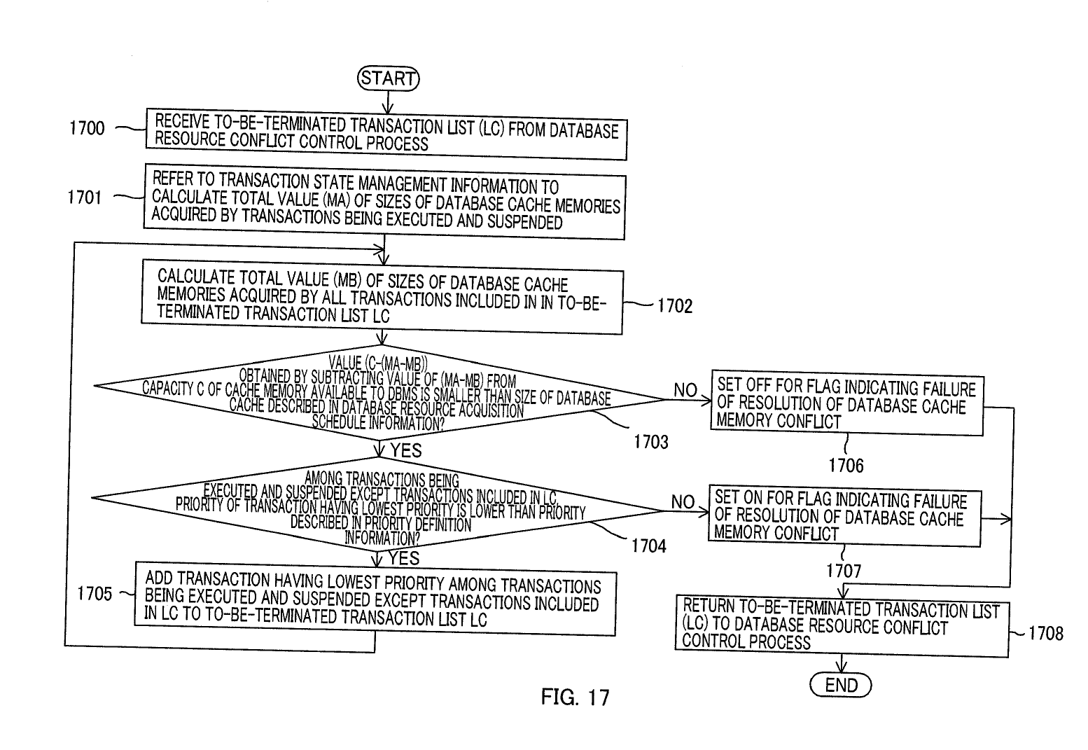

At step 1207, the database resource conflict control unit 108 judges whether a conflict of the database cache memory occurs between the transaction process of the transaction identifier T and the transaction processes being executed and suspended and if the conflict occurs, a determination is made on the transaction processes that must be terminated to resolve the conflict. Details of this process (hereinafter, a database cache memory conflict control process) will be described later with reference to FIG. 17.

At step 1208, the database resource conflict control unit 108 checks whether a flag indicating a failure of resolution of the database cache memory conflict is turned on. If the lag indicating a failure of resolution of the database cache memory conflict is turned on (YES at step 1208), the process goes to step 1215. If the lag indicating a failure of resolution of the database cache memory conflict is turned on (YES at step 1208), the process goes to step 1215. If the flag is not turned on (is turned off) (NO at step 1208), the process goes to step 1209.

At step 1215, the database resource conflict control unit 108 transmits a message notifying of a failure of resolution of the conflict of database resources to the transaction process request accepting unit 107 and the process is terminated.

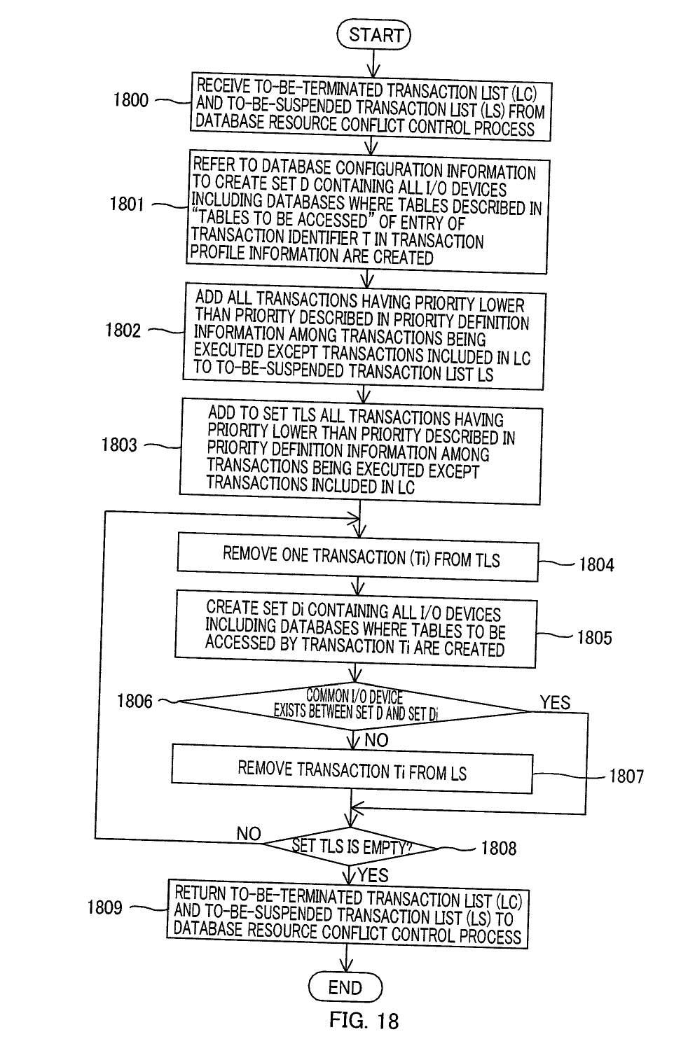

At step 1209, the database resource conflict control unit 108 judges whether a conflict of the I/O device use right occurs between the transaction process of the transaction identifier T and the transaction processes being executed and suspended and if the conflict occurs, a determination is made on the transaction processes that must be suspended or terminated to resolve the conflict. Details of this process (hereinafter, an I/O device conflict control process) will be described later with reference to FIG. 18.

At step 1210, the database resource conflict control unit 108 checks whether the database task management table (1003) of the transaction state management information 224 includes an array element with “0” registered in the field registering a transaction identifier (whether a database task without an allocated transaction process exists). If the corresponding array element exists (a database task without an allocated transaction process exists) (YES at step 1210), the process goes to step 1213. If no corresponding array element exists (no database task without an allocated transaction process exists) (NO at step 1210), the process goes to step 1211.

At step 1211, the database resource conflict control unit 108 checks whether both the sets LC and LS are empty sets (include no element). If the both sets are empty (YES at step 1211), the process goes to S1212. If one of the sets is not empty (NO at step 1212), the process goes to step 1213.

At step 1212, the database resource conflict control unit 108 adds to the LS a transaction process corresponding to the transaction identifier registered for the transaction state management structure having the smallest priority value (the lowest priority) among the transaction state management structures retained by the transaction-in-execution management list (1001) of the transaction state management information 224.

At step 1213, the database resource conflict control unit 108 inputs the to-be-terminated transaction list LC, the to-be-suspended transaction list LS, the transaction identifier information 103, the priority definition information 104, the database resource acquisition schedule information 105, and the available memory area information 106 to the database task control unit 109 and instructs the database task control unit 109 to start the process.

At step 1214, the database resource conflict control unit 108 transmits a message notifying of the completion of execution of the process of the database resource conflict control program to the transaction process request accepting unit 107 and the process is terminated.

### <Database Task Control Process>

FIGS. 13A, 13B, 13C, 13D, 13E, 13F, and 13G are explanatory flowcharts of details of the database task control process (process at step 304).

At step 1300, the database task control unit 109 sets “0” for the process phase of the database task control unit 109.

At step 1301, the database task control unit 109 checks whether the process phase of the database task control unit 109 is “0”. If the process phase is “0” (YES at step 1301), the process goes to step 1302. If the process phase is not “0” (NO at step 1301), the process goes to step 1323 of FIG. 13B.

At step 1302, the database task control unit 109 checks whether a message giving an instruction for starting the process of the database task control unit 109 is received from the database resource conflict control unit 108. If the message giving an instruction for starting the process is received (YES at step 1302), the process goes to step 1303. If the message giving an instruction for starting the process is not received (NO at step 1302), the process goes to step 1305.

At step 1303, the database task control unit 109 receives the to-be-terminated transaction list LC that retains the transaction processes to be terminated, the to-be-suspended transaction list LS that retains the transaction processes to be suspended, the transaction identifier information 103, the priority definition information 104, the database resource acquisition schedule information 105, and the available memory area information 106 from the database resource conflict control unit 108.

At step 1304, the database task control unit 109 sets “1” for the process phase of the database task control unit 109 and the process goes back to step 1301.

At step 1305, the database task control unit 109 checks whether a message notifying of the completion of a transaction process (denoted by TE) is received from the database task 111. If the message is received (YES at step 1305), the process goes to step 1306. If the message is not received (NO at step 1305), the process goes to step 1310.

At step 1306, the database task control unit 109 removes a transaction state management structure (denoted by STE) corresponding to the transaction process TE from the transaction-in-execution management list (1001) of the transaction state management information 224.

At step 1307, the database task control unit 109 sets DBN1 as a value of the database task number registered in the transaction state management structure STE.

At step 1308, the database task control unit 109 registers “0” in the field (1010) registering a transaction identifier forming a set of two fields having a value identical to DBN3 registered for the database task number of the database task management table (1003) of the transaction state management information 224.

At step 1309, the database task control unit 109 detects all the transaction state management structures having values registered for the suspension requesting transaction identifiers identical to the transaction identifier of the transaction process TE among the transaction state management structures retained in the transaction-in-suspension management list (1002) of the transaction state management information 224 and sets “restart available” for the restart availability flags of those transaction state management structures, and the process goes back to step 1301.

At step 1310, the database task control unit 109 checks whether a transaction state management structure having the restart availability flag of “restart available” exists among the transaction state management structures retained in the transaction-in-suspension management list (1002) of the transaction state management information 224. If the corresponding transaction state management structure exists (YES at step 1310), the process goes to step 1311. If no corresponding transaction state management structure exists (NO at step 1310), the process goes back to step 1301.

At step 1311, the database task control unit 109 detects a transaction state management structure (denoted by STH) having the highest priority value (having a higher priority) among the transaction state management structures having the restart availability flags of “restart available” retained in the transaction-in-suspension management list (1002) of the transaction state management information 224.

At step 1312, the database task control unit 109 checks whether “0” is registered in the field (1014) registering the database task number of the transaction state management structure STH. If “0” is registered (YES at step 1312), the process goes to step 1313. If “0” is not registered (NO at step 1312), the process goes to step 1314.

At step 1313, the database task control unit 109 checks whether the database task management table (1003) of the transaction state management information 224 includes an array element with “0” registered in the field registering a transaction identifier (whether a database task without an allocated transaction process exists). If the corresponding array element exists (a database task without an allocated transaction process exists) (YES at step 1313), the process goes to step 1316. If no corresponding array element exists (no database task without an allocated transaction process exists) (NO at step 1313), the process goes to step 1301.

At step 1314, the database task control unit 109 instructs the database task corresponding to the database task number registered in the transaction state management structure STH to restart the transaction process corresponding to the transaction identifier registered in the transaction state management structure STH.

At step 1315, the database task control unit 109 removes the transaction state management structure STH from the transaction-in-suspension management list (1002) to add the structure to the transaction-in-execution management list (1001), and the process goes back to step 1301.

At step 1316, the database task control unit 109 sets TR as a transaction process corresponding to the transaction identifier registered in the transaction state management structure STH.

At step 1317, the database task control unit 109 reads a database task context corresponding to the transaction process TR from the context saving area 113 to recover the read database task context in the database task corresponding to the database task number of the array element with “0” registered in the field registering a transaction identifier in the database task management table (1003) of the transaction state management information 224.

At step 1318, the database task control unit 109 deletes the database task context corresponding to the transaction process TR from the context saving area 113.

At step 1319, the database task control unit 109 gives an instruction for restarting the transaction process TR to the database task having the recovered database task context corresponding to the transaction process TR.

At step 1320, the database task control unit 109 removes the transaction state management structure STH from the transaction-in-suspension management list (1002) to add the structure to the transaction-in-execution management list (1001).

At step 1321, the database task control unit 109 registers a database task number (denoted by DBN2) of the database task having the recovered database task context corresponding to the transaction process TR in the field (1014) registering the database task number of the transaction state management structure STH.

At step 1322, the database task control unit 109 registers the transaction identifier of the transaction process TR into the field (1010) registering a transaction identifier of the array element having a value identical to DBN2 registered in the field (1009) registering a database task number of the database task management table (1003) of the transaction state management information 224 and the process goes to step 1301.

At step 1323, it is checked whether the process phase of the database task control unit 109 is “1”. If the process phase is “1” (YES at step 1323), the process goes to step 1324. If the process phase is not “1” (NO at step 1323), the process goes to step 1367 of FIG. 13D.

At step 1324 of FIG. 13B, the database task control unit 109 checks whether the to-be-terminated transaction list LC retaining to-be-terminated transaction processes received from the database resource conflict control unit 108 is empty (does not include a transaction process). If the list is empty (does not include a transaction process) (YES at step 1324), the process goes to step 1348 of FIG. 13C. If the list is not empty (includes transaction processes) (NO at step 1324), the process goes to step 1325.

At step 1325, the database task control unit 109 selects one transaction process (denoted by TC) to be terminated from the to-be-terminated transaction list LC.

At step 1326, the database task control unit 109 refers to the transaction state management information 224 to check whether the transaction-in-suspension management list (1002) includes a transaction state management structure having the transaction identifier of the transaction process TC registered in the field (1011) registering a transaction identifier (whether the transaction process TC is being suspended). If the corresponding transaction state management structure is included (the transaction process TC is being suspended) (YES at step 1326), the process goes to step 1329. If the corresponding transaction state management structure is not included (the transaction process TC is not being suspended) (NO at step 1326), the process goes to step 1327.

At step 1327, the database task control unit 109 gives an instruction for terminating the transaction process TC to a database task corresponding to the database number registered in the field registering the database task number of the transaction state management structure having the transaction identifier of the transaction process TC.

At step 1328, the database task control unit 109 sets “2” for the process phase of the database task control unit 109 and the process goes back to step 1301.

At step 1329, the database task control unit 109 checks whether “0” is registered in the field (1014) registering the database task number of the transaction state management structure having the transaction identifier of the transaction process TC. If “0” is registered in the field (1014) (YES at step 1329), the process goes to step 1330. If “0” is not registered in the field (1014) (NO at step 1329), the process goes to step 1331.

At step 1330, the database task controlling unit 109 checks whether the database task management table (1003) of the transaction state management information 224 includes an array element with “0” registered in the field registering a transaction identifier. If the corresponding array element exists (YES at step 1330), the process goes to step 1332. If the corresponding array element does not exist (NO at step 1330), the process goes to step 1331.

At step 1331, the database task controlling unit 109 refers to the transaction state management information 224 to detect the transaction state management structure having the smallest priority value (1012) (the lowest priority) among the transaction state management structures having in the field (1011) registering a transaction identifier the transaction identifiers registered in the fields (1010) registering the transaction identifiers of the array elements in the database task management table (1003) and sets TL as a transaction process corresponding to the transaction identifier registered in the transaction state management structure and the process goes to step 1337.

At step 1337, the database task controlling unit 109 refers to the transaction state management information 224 to check whether the transaction-in-suspension management list includes a transaction state management structure having the transaction identifier of the transaction process TL (whether the transaction process TL is being suspended). If the corresponding transaction state management structure is included (the transaction process TL is being suspended) (YES at step 1337), the process goes to step 1338. If the corresponding transaction state management structure is no included (the transaction process TL is not being suspended) (NO at step 1337), the process goes to step 1345.

At step 1332, the database task control unit 109 reads a database task context corresponding to the transaction process TC from the context saving area 113 to recover the read database task context in the database task corresponding to the database task number of the array element with “0” registered in the field registering a transaction identifier in the database task management table (1003) of the transaction state management information 224.

At step 1333, the database task control unit 109 deletes the database task context corresponding to the transaction process TC from the context saving area 113.

At step 1334, the database task control unit 109 gives an instruction for restarting the transaction process TR to the database task having the recovered database task context corresponding to the transaction process TC.

At step 1335, the database task control unit 109 gives an instruction for terminating the transaction process TR to the database task giving the instruction for restarting the transaction process TR.

At step 1336, the database task control unit 109 sets “2” for the process phase of the database task control unit 109 and the process goes back to step 1301.

At step 1338, the database task control unit 109 sets “3” for the process phase of the database task control unit 109.

At step 1339, the database task control unit 109 saves into a context saving area 113 a database task context of a database task (denoted by DB) corresponding to the database task number registered in the field (1014) registering a database task number of the transaction state management structure having the transaction identifier of the transaction process TL.

At step 1340, the database task control unit 109 initializes the database task DB.

At step 1341, the database task control unit 109 reads a database task context corresponding to the transaction process TC from the context saving area 113 to recover the database task context in the database task DB.

At step 1342, the database task control unit 109 deletes the database task context corresponding to the transaction process TC from the context saving area 113.

At step 1343, the database task control unit 109 gives an instruction for restarting the transaction process TR to the database task DB.

At step 1344, the database task control unit 109 gives an instruction for terminating the transaction process TR to the database task DB and the process goes back to step 1301.

At step 1345, the database task control unit 109 sets “4” for the process phase of the database task control unit 109.

At step 1346, the database task control unit 109 gives an instruction for suspending the transaction process TL to a database task corresponding to the database task number registered in the field (1014) registering the database task number of the transaction state management structure having the transaction identifier of the transaction process TL.

At step 1347, the database task control unit 109 checks whether a message notifying of the completion of suspension of the transaction process TL is received from the database task 111. If the message is received (YES at step 1347), the process goes to step 1339. If the message is not received (NO at step 1347), the process goes back to repeat step 1347.

At step 1348 of FIG. 13C, the database task control unit 109 checks whether the to-be-suspended transaction list LS retaining to-be-terminated transaction processes received from the database resource conflict control unit 108 is empty (does not include a transaction process). If the list is empty (does not include a transaction process) (YES at step 1348), the process goes to step 1351. If the list is not empty (includes transaction processes) (NO at step 1348), the process goes to step 1349.

At step 1349, the database task control unit 109 selects one transaction process (denoted by TS) to be terminated from the to-be-suspended transaction list LS, refers to the transaction state management information 224, and gives an instruction for suspending the transaction process TS to a database task corresponding to the database number registered in the field registering the database task number of the transaction state management structure having the transaction identifier of the transaction process TS.

At step 1350, the database task control unit 109 sets “2” for the process phase of the database task control unit 109 and the process goes back to step 1301.

At step 1351, the database task control unit 109 checks whether the database task management table (1003) of the transaction state management information 224 includes an array element with “0” registered in the field registering a transaction identifier. If the corresponding array element exists (YES at step 1351), the process goes to step 1352. If the corresponding array element does not exist (NO at step 1351), the process goes to step 1353.

At step 1352, the database task control unit 109 selects one array element with “0” registered in the field registering a transaction identifier in the database task management table (1003) of the transaction state management information 224 and allocates the transaction process in accordance with the transaction identifier information 103, the priority definition information 104, the database resource acquisition schedule information 105, and the available memory area information 106 to the database task corresponding to the database task number registered in the field (1009) registering the database task number of the array element, and the process goes to step 1363.

At step 1353, the database task control unit 109 checks whether the available memory area information 106 includes valid descriptions of a memory address and a memory area size. If valid descriptions are included (YES at step 1353), the process goes to step 1354. If valid descriptions are not included (NO at step 1353), the process goes to step 1357.

At step 1354, the database task control unit 109 generates a new database task (denoted by DBT) in the memory area within the shared heap memory 112 starting from the memory address described in the field (801) describing the memory address in the available memory area information 106.

At step 1355, the database task control unit 109 allocates the transaction process in accordance with the transaction identifier information 103, the priority definition information 104, the database resource acquisition schedule information 105, and the available memory area information 106 to the database task DBT generated in the memory area within the shared heap memory 112.

At step 1356, the database task control unit 109 generates a transaction state management structure (denoted by STN) having the transaction identifier described in the transaction identifier information 103, the priority value described in the priority definition information 104, the value (necessary amount) of the database cache memory described in the database resource acquisition schedule information 105 in the field (1011) registering a transaction identifier, the field (1012) registering a priority value, and the field (1013) registering a database cache size, respectively, registers “0” in each of the field (1014) registering a database task number, the field (1015) registering a suspension requesting transaction identifier, and the field (1016) registering a restart possibility flag of the transaction state management structure STN, and adds the transaction state management structure STN to the transaction-in-execution management list and the process goes to step 1366.

Since it is determined whether a valid memory address is described in the available memory area information 106 and, if described, the main memory unit 206 is actively utilized to generate the database task executing the transaction process instructed by the application program 211 as above, the process may be executed at high speed.

At step 1357, the database task control unit 109 detects the transaction state management structure (denoted by STS) having the smallest priority value (the lowest priority) among the transaction state management structures having the database task numbers other than “0” in the transaction-in-suspension management list (1002) of the transaction state management information 224.

At step 1358, the database task control unit 109 saves into the context saving area 113 a database task context of a database task corresponding to the database task number (assumed as DBN3) registered in the field (1014) registering the database task number of the transaction state management structure STS.

At step 1359, the database task control unit 109 initializes the database task corresponding to the database task number DBN3.

At step 1360, the database task control unit 109 registers “0” in the field (1010) registering a transaction identifier forming a set of two fields having a value identical to DBN1 registered for the database task number of the database task management table (1003) of the transaction state management information 224.

At step 1361, the database task control unit 109 registers “0” in the field (1014) registering the database task number of the transaction state management structure STS.

At step 1362, the database task control unit 109 allocates the transaction process in accordance with the transaction identifier information 103, the priority definition information 104, the database resource acquisition schedule information 105, and the available memory area information 106 to the database task corresponding to the database number of DBN3.

At step 1363, the database task control unit 109 generates a transaction state management structure (denoted by STN) having the transaction identifier described in the transaction identifier information 103, the priority value described in the priority definition information 104, the value (necessary amount) of the database cache memory described in the database resource acquisition schedule information 105 in the field (1011) registering a transaction identifier, the field (1012) registering a priority value, and the field (1013) registering a database cache size, respectively, registers “0” in each of the field (1015) registering a suspension requesting transaction identifier and the field (1016) registering a restart possibility flag of the transaction state management structure STN, and adds the transaction state management structure STN to the transaction-in-execution management list.

At step 1364, the database task control unit 109 registers the database task number DBN3 in the field (1014) registering the database task number of the transaction state management structure STN.

At step 1365, the database task control unit 109 registers the transaction identifier described in the transaction identifier information 103 into the field (1010) registering a transaction identifier of the array element having a value identical to DBN3 registered in the field (1009) registering a database task number of the database task management table (1003) of the transaction state management information 224.

At step 1366, the database task control unit 109 sets “0” for the process phase of the database task control unit 109 and the process goes back to step 1301.

At step 1367 of FIG. 3D, the database task control unit 109 checks whether the process phase of the database task control unit 109 is “2”. If the process phase is “2” (YES at step 1367), the process goes to step 1368. If the process phase is not “2” (NO at step 1367), the process goes to step 1376.

At step 1368, the database task control unit 109 checks whether a message notifying of the completion of a transaction process (denoted by TCF) is received from the database task 111. If the message is received (YES at step 1368), the process goes to step 1369. If the message is not received (NO at step 1368), the process goes to step 1372.

At step 1369, the database task control unit 109 removes the transaction state management structure corresponding to the transaction process TCF from the transaction-in-execution management list (1001) of the transaction state management information 224.

At step 1370, the database task control unit 109 deletes the transaction process TCF from the to-be-terminated transaction list LC.

At step 1371, the database task control unit 109 sets “1” for the process phase of the database task control unit 109 and the process goes back to step 1301.

At step 1372, the database task control unit 109 checks whether a message notifying of the completion of suspension of a transaction process (denoted by TSF) is received from the database task 111. If the message is received (YES at step 1372), the process goes to step 1373. If the message is not received (NO at step 1372), the process goes back to step 1301.

At step 1373, the database task control unit 109 removes the transaction state management structure corresponding to the transaction process TSF from the transaction-in-execution management list (1001) of the transaction state management information 224 to add the structure to the transaction-in-suspension management list (1001).

At step 1374, the database task control unit 109 deletes the transaction process TSF from the to-be-suspended transaction list LS.

At step 1375, the database task control unit 109 sets “1” for the process phase of the database task control unit 109 and the process goes back to step 1301.

At step 1376, the database task control unit 109 checks whether or not the process phase of the database task control unit 109 is “3” or “4”. If the process phase is “3” or “4” (YES at step 1376), the process goes to step 1377. If the process phase is not “3” or “4” (YES at step 1376), the process goes to step 1385.

At step 1377, the database task control unit 109 checks whether a message notifying of the completion of termination of a transaction process (denoted by TF) is received from the database task 111. If the message is received (YES at step 1377), the process goes to step 1378. If the message is not received (NO at step 1377), the process goes back to step 1301.

At step 1378, the database task control unit 109 removes the transaction state management structure corresponding to the transaction process TF from the transaction-in-execution management list (1001) of the transaction state management information 224.

At step 1379, the database task control unit 109 reads a database task context corresponding to the transaction process TL from the context saving area 113 to recover the database task context in the database task corresponding to the database task number registered in the field (1014) registering the database task number of the transaction state management structure corresponding to the transaction process TF.

At step 1380, the database task control unit 109 deletes the database task context corresponding to the transaction process TL from the context saving area 113.

At step 1381, the database task control unit 109 checks whether the process phase of the database task control unit 109 is “4”. If the process phase is “4” (YES at step 1381), the process goes to step 1382. If the process phase is not “4” (NO at step 1381), the process goes to step 1383.

At step 1382, the database task control unit 109 gives an instruction for restarting the transaction process TL to a database task corresponding to the database task number registered in the field (1014) registering the database task number of the transaction state management structure having the transaction identifier of the transaction process TL.

At step 1383, the database task control unit 109 deletes the transaction process TF from the to-be-suspended transaction list LS.

At step 1384, the database task control unit 109 sets “1” for the process phase of the database task control unit 109 and the process goes back to step 1301.

At step 1385, the database task control unit 109 checks whether an instruction for stopping the process of the database task control unit 109 is received. If the instruction for stopping the process is received (YES at step 1385), the process of the database task control unit 109 is terminated. If the instruction for stopping the process is not received (NO at step 1385), the process goes back to step 1301.

In the above description, removing the transaction state management structure from the transaction-in-execution management list means the following facts.

(a) If the transaction state management structure to be removed is referenced by the pointer (1017) from the area (1004) for retaining a pointer referring to the beginning of the transaction-in-execution management list and refers to the area (1004) for retaining a pointer referring to the beginning of the transaction-in-execution management list through the pointer (1019), pointers are deleted which are the pointer (1017) from the area (1004) for retaining a pointer referring to the beginning of the transaction-in-execution management list to the transaction state management structure to be removed and the pointer (1019) from the transaction state management structure to be removed to the area (1004) for retaining a pointer referring to the beginning of the transaction-in-execution management list.

(b) If the transaction state management structure to be removed is referenced by the pointer (1017) from the area (1004) for retaining a pointer referring to the beginning of the transaction-in-execution management list and refers to another transaction state management structure through the pointer (1018), pointers are deleted which are the pointer (1017) from the area (1004) for retaining a pointer referring to the beginning of the transaction-in-execution management list to the transaction state management structure to be removed and the pointer (1018) from the transaction state management structure to be removed to another transaction state management structure and a pointer is generated which is the pointer (1017) from the area (1004) for retaining a pointer referring to the beginning of the transaction-in-execution management list to another transaction state management structure referenced by the pointer from the transaction state management structure to be removed before the removal of the transaction state management structure to be removed.

(c) If the transaction state management structure to be removed is referenced by the pointer (1018) from another transaction state management structure and refers to another transaction state management structure through the pointer (1018), pointers are deleted which are the pointer from another transaction state management structure to the transaction state management structure to be removed and the pointer from the transaction state management structure to be removed to another transaction state management structure and a pointer is generated which is the pointer from another transaction state management structure referring through the pointer to the transaction state management structure to be removed to another transaction state management structure referenced through the pointer by the transaction state management structure to be removed.

(d) If the transaction state management structure to be removed is referenced by the pointer (1018) from another transaction state management structure and refers through the pointer (1019) to the area (1004) for retaining a pointer referring to the beginning of the transaction-in-execution management list, pointers are deleted which are the pointer from another transaction state management structure to the transaction state management structure to be removed and the pointer (1019) from the transaction state management structure to be removed to the area (1004) for retaining a pointer referring to the beginning of the transaction-in-execution management list and a pointer is generated which is the pointer to the area (1004) for retaining a pointer referring to the beginning of the transaction-in-execution management list from another transaction state management structure referring through the pointer to the transaction state management structure to be removed before the removal of the transaction state management structure to be removed.

Removing the transaction state management structure from the transaction-in-suspension management list means the following facts.

(a) If the transaction state management structure to be removed is referenced by the pointer (1020) from the area (1007) for retaining a pointer referring to the beginning of the transaction-in-suspension management list and refers to the area (1007) for retaining a pointer referring to the beginning of the transaction-in-suspension management list through the pointer (1021), pointers are deleted which are the pointer (1020) from the area (1007) for retaining a pointer referring to the beginning of the transaction-in-suspension management list to the transaction state management structure to be removed and the pointer (1021) from the transaction state management structure to be removed to the area (1007) for retaining a pointer referring to the beginning of the transaction-in-suspension management list.

(b) If the transaction state management structure to be removed is referenced by the pointer (1020) from the area (1007) for retaining a pointer referring to the beginning of the transaction-in-suspension management list and refers to another transaction state management structure through the pointer, pointers are deleted which are the pointer (1020) from the area (1007) for retaining a pointer referring to the beginning of the transaction-in-suspension management list to the transaction state management structure to be removed and the pointer from the transaction state management structure to be removed to another transaction state management structure and a pointer is generated which is the pointer (1020) from the area (1007) for retaining a pointer referring to the beginning of the transaction-in-suspension management list to another transaction state management structure referenced by the pointer from the transaction state management structure to be removed before the removal of the transaction state management structure to be removed.

(c) If the transaction state management structure to be removed is referenced by the pointer from another transaction state management structure and refers to another transaction state management structure through the pointer, pointers are deleted which are the pointer from another transaction state management structure to the transaction state management structure to be removed and the pointer from the transaction state management structure to be removed to another transaction state management structure and a pointer is generated which is the pointer from another transaction state management structure referring through the pointer to the transaction state management structure to be removed to another transaction state management structure referenced through the pointer by the transaction state management structure to be removed.

(d) If the transaction state management structure to be removed is referenced by the pointer from another transaction state management structure and refers through the pointer (1021) to the area (1007) for retaining a pointer referring to the beginning of the transaction-in-execution management list, pointers are deleted which are the pointer from another transaction state management structure to the transaction state management structure to be removed and the pointer (1021) from the transaction state management structure to be removed to the area (1007) for retaining a pointer referring to the beginning of the transaction-in-suspension management list and a pointer is generated which is the pointer to the area (1007) for retaining a pointer referring to the beginning of the transaction-in-suspension management list from another transaction state management structure referring through the pointer to the transaction state management structure to be removed before the removal of the transaction state management structure to be removed.

Adding the transaction state management structure to the transaction-in-execution management list means the following facts.

Before the addition of the transaction state management structure to be added, a pointer is deleted which is the pointer (1017) from the area (1004) for retaining a pointer referring to the beginning of the transaction-in-execution management list to the transaction state management structure, and pointers are generated which are the pointer from the area (1004) for retaining a pointer referring to the beginning of the transaction-in-execution management list to the transaction state management structure to be added and the pointer from the transaction state management structure to be added to the transaction state management structure referenced by the pointer (1017) from the area (1004) for retaining a pointer referring to the beginning of the transaction-in-execution management list before the addition of the transaction state management structure to be added.

Adding the transaction state management structure to the transaction-in-suspension management list means the following facts.

Before the addition of the transaction state management structure to be added, a pointer is deleted which is the pointer (1020) from the area (1007) for retaining a pointer referring to the beginning of the transaction-in-suspension management list to the transaction state management structure, and pointers are generated which are the pointer from the area (1007) for retaining a pointer referring to the beginning of the transaction-in-suspension management list to the transaction state management structure to be added and the pointer from the transaction state management structure to be added to the transaction state management structure referenced by the pointer (1020) from the area (1007) for retaining a pointer referring to the beginning of the transaction-in-suspension management list before the addition of the transaction state management structure to be added.

Saving the database task context means that a database task context consisting of the register information, the runtime stack information, and the global variable area information of the database task is generated and stored in the storage device 207.

Recovering the database task context means that the database task context is read from the storage device 207 to set the register values retained in the register information of the database task context to corresponding registers, to duplicate a snapshot of a runtime stack included in the runtime stack information onto a memory area retaining the runtime stack of the database task, and to duplicate a snapshot of a global variable area included in the global variable area information onto a memory area retaining the global variable area of the database task.

The initialization of the database task means that contents of the memory areas retaining the runtime stack and the global variable area of the database task are returned to the same contents at the start of the process of the database task.

Allocating the transaction process to the database task means that an instruction is given to the database task to start executing the transaction process having the transaction identifier described in the transaction identifier information 103 input from the application program 211 and the priority value described in the priority definition information 104 and capable of acquiring the database resources described in the database resource acquisition schedule information 105.

The memory address and the memory area size described in the available memory information being valid means that the description of the field (801) describing a start address of the memory area in the available memory information 216 is not “n/a” and that the description of the field (802) describing a size of the memory area is not “0”.

### <Database Task Process>

FIGS. 14A, 14B, and 14C are flowcharts of the process procedure of the database task process described with reference to FIG. 2.

At step 1400, the database task 111 sets “0” for the process phase of the database task 111.

At step 1401, the database task 111 checks whether a message requesting the execution of the transaction process is received from the database task control unit 109. If the message is received (YES at step 1401), the procedure goes to step 1402. If the message is not received (NO at step 1401), the procedure goes to step 1409.

At step 1402, the database task 111 checks whether the process phase of the database task 111 is “0”. If the “process phase” is “0” (YES at step 1402), the procedure goes to step 1404. If the “process phase” is not “0” (NO at step 1402), the procedure goes to step 1403.

At step 1403, the database task 111 transmits a message notifying of unacceptability of a new transaction process due to the transaction being processed to the database task control unit 109 and the procedure goes back to step 1401.

At step 1404, the database task 111 accepts the transaction process request through input of a transaction identifier (denoted by T) described in the transaction identifier information 103 from the database task control unit 109.

At step 1405, the database task 111 checks whether the transaction identifier T is included in the fields (1101) describing transaction identifiers of the transaction profile information 114. If the transaction identifier T is included (YES at step 1405), the procedure goes to step 1406. If the transaction identifier T is not included (NO at step 1405), the procedure goes to step 1407.

At step 1406, the database task 111 sets “1A” for the process phase of the database task 111 and the procedure goes back to step 1401.

At step 1407, the database task 111 adds the transaction identifier T to the fields (1101) describing transaction identifiers of the transaction profile information 114 to form a set of four fields including the transaction identifier T in the field (1101) describing a transaction identifier.

At step 1408, the database task 111 sets “1B” for the process phase of the database task 111 and the procedure goes back to step 1401.

At step 1409, the database task 111 checks whether or not the process phase of the database task 111 is “1A” or “1B”. If the process phase is “1A” or “1B” (YES at step 1409), the procedure goes to step 1410. If the process phase is not “1A” or “1B” (YES at step 1409), the procedure goes to step 1421.

At step 1410, the database task 111 checks whether an unprocessed query process is included among the query processes included in the transaction process requested by the application program 211. If an unprocessed query process is included (YES at step 1410), the procedure goes to step 1412. If an unprocessed query process is not included (NO at step 1410), the procedure goes to step 1411.

At step 1411, the database task 111 sets “2” for the process phase of the database task 111 and the procedure goes back to step 1401.

At step 1412, the database task 111 acquires a query process (denoted by Q) to be executed first in accordance with the order of execution of the query processes among the unprocessed query processes included in the transaction process requested by the application program 211.

At step 1413, the database task 111 checks whether the content of the query process Q is generation of a table in the database 116 (step 1413). If the content of the query process Q is generation of a table (YES at step 1413), the procedure goes to step 1414. If the content of the query process Q is not generation of a table (NO at step 1413), the procedure goes to step 1415.

At step 1414, the database task 111 describes a name of a table generated due to the query process Q into the field (403) describing a name of the table corresponding to the field (401) describing a name of the database where a table will be generated due to the query process Q in the database configuration information 115.

At step 1415, the database task 111 executes the query process Q.

A result of the execution of the query process Q is transmitted to the application program 211 (step 1416).

At step 1417, the database task 111 checks whether the process phase of the database task 111 is “1A”. If the process phase is “1A” (YES at step 1417), the procedure goes to step 1420. If the process phase is not “1A” (NO at step 1417), the procedure goes to step 1418.

At step 1418, the database task 111 additionally describes a name of the table accessed during the execution of the query process Q into the field (1102) describing a table to be accessed in the set of four elements including the transaction identifier T in the field (1101) describing a transaction identifier in the transaction profile information 114.

At step 1419, the database task 111 additionally describes names of the database objects having the shared lock and the exclusive lock acquired during the execution of the query process Q into the field (1104) describing database objects having the shared lock acquired and the field (1105) describing database objects having the exclusive lock acquired, respectively, in the set of four elements including the transaction identifier T in the field (1101) describing a transaction identifier in the transaction profile information 114.

At step 1420, the database task 111 sets “0” for the process phase of the database task 111 and the procedure goes back to step 1401.

At step 1421, the database task 111 checks whether the process phase of the database task 111 is “2”. If the process phase is “2” (YES at step 1421), the procedure goes to step 1422. If the process phase is not “2” (NO at step 1421), the procedure goes to step 1423.

At step 1422, the database task 111 transmits a message notifying of the completion of execution of the transaction process to the database task control unit 109 to terminate the process of the database task 111.

At step 1423, the database task 111 checks whether a message requesting the termination of the transaction process is received from the database task control unit 109. If the message is received (YES at step 1423), the procedure goes to step 1424. If the message is not received (NO at step 1423), the procedure goes to step 1427.

At step 1424, the database task 111 checks whether the process phase of the database task 111 is not “0”. If the process phase is not “0” (YES at step 1424), the procedure goes to step 1425. If the process phase is “0” (NO at step 1424), the procedure goes to step 1426.

At step 1425, the database task 111 performs the rollback of the transaction process.

At step 1426, the database task 111 transmits a message notifying of the completion of termination of the transaction process to the database task control unit 109 to terminate the process of the database task 111.

At step 1427 of FIG. 14B, the database task 111 checks whether a message requesting the suspension of the transaction process is received from the database task control unit 109. If the message is received (YES at step 1427), the procedure goes to step 1428. If the message is not received (NO at step 1427), the procedure goes to step 1436.

At step 1428, the database task 111 checks whether the process phase of the database task 111 is “1A”. If the process phase is “1A” (YES at step 1428), the procedure goes to step 1429. If the process phase is not “1A” (NO at step 1428), the procedure goes to step 1430.

At step 1429, the database task 111 sets “1AS” for the process phase of the database task 111 and the procedure goes to step 1435.

At step 1430, the database task 111 checks whether the process phase of the database task 111 is “1B”. If the process phase is “1B” (YES at step 1430), the procedure goes to step 1431. If the process phase is not “1B” (NO at step 1430), the procedure goes to step 1432.

At step 1431, the database task 111 sets “1BS” for the process phase of the database task 111 and the procedure goes to step 1435.

At step 1432, the database task 111 checks whether the process phase of the database task 111 is “2”. If the process phase is “2” (YES at step 1432), the procedure goes to step 1433. If the process phase is not “2” (NO at step 1432), the procedure goes to step 1434.

At step 1433, the database task 111 sets “1S” for the process phase of the database task 111 and the procedure goes to step 1435.

At step 1434, the database task 111 sets “0S” for the process phase of the database task 111.

At step 1435, the database task 111 transmits a message notifying of the completion of suspension of the transaction process to the database task control unit 109 and the procedure goes back to step 1401.

At step 1436, the database task 111 checks whether a message requesting the restart of the transaction process is received from the database task control unit 109. If the message is received (YES at step 1436), the procedure goes to step 1437. If the message is not received (NO at step 1436), the procedure goes back to step 1401.

At step 1437, the database task 111 checks whether the process phase of the database task 111 is “1AS”. If the process phase is “1AS” (YES at step 1437), the procedure goes to step 1438. If the process phase is not “1AS” (NO at step 1437), the procedure goes to step 1439.

At step 1438, the database task 111 sets “1A” for the process phase of the database task 111 and the procedure goes back to step 1401.

At step 1439, the database task 111 checks whether the process phase of the database task 111 is “1BS”. If the process phase is “1BS” (YES at step 1439), the procedure goes to step 1440. If the process phase is not “1BS” (NO at step 1439), the procedure goes to step 1441.

At step 1440, the database task 111 sets “1B” for the process phase of the database task 111 and the procedure goes back to step 1401.

At step 1441, the database task 111 checks whether the process phase of the database task 111 is “2S”. If the process phase is “2S” (YES at step 1441), the procedure goes to step 1442. If the process phase is not “2S” (NO at step 1441), the procedure goes to step 1442.

At step 1442, the database task 111 sets “2” for the process phase of the database task 111 and the procedure goes back to step 1401.

At step 1443, the database task 111 sets “0” for the process phase of the database task 111 and the procedure goes back to step 1401.

The acceptance of the transaction process request by the database task 111 means that a message is transmitted to notify the application program 211 that the execution of the transaction process can be started to receive query processes included in the transaction process requested by the application program 211 in accordance with the order of the processes.

### <Shared Lock Conflict Control Process>

FIG. 15 is an explanatory flowchart of details of the shared lock conflict control process (process at step 1204) of FIG. 12.

At step 1500, the database resource conflict control unit 108 receives the to-be-terminated transaction list (LC) and the to-be-suspended transaction list (LS) from the database resource conflict control unit 108.

At next step 1501, the database resource conflict control unit 108 generates a set (denoted by KS) of elements consisting of all the database objects described in the field (1104) describing database objects having the shared lock acquired in a set of four fields corresponding to the transaction identifier T of the transaction profile information 114.

At step 1502, the database resource conflict control unit 108 selects one database object (denoted by DS) from the database objects included in the set KS and removes the database object from the set KS.

At step 1503, the database resource conflict control unit 108 refers to the exclusive resource management information 225 to detect the transaction processes acquiring the exclusive lock for the database object DS and checks whether the detected transaction processes include a transaction process having a priority value smaller (a priority lower) than the priority described in the priority definition information 104. If the corresponding transaction process is included (YES at step 1503), the process goes to step 1504. If the corresponding transaction process is not included (NO at step 1503), the process goes to step 1505.

At step 1504, the database resource conflict control unit 108 adds to the LC all the transaction processes having the values smaller (priorities lower) than the priority described in the priority definition information 104 among the transaction processes acquiring the exclusive lock for the database object DS.

At step 1505, the database resource conflict control unit 108 checks whether the set KS is empty. If the set KS is empty (YES at step 1505), the process goes to step 1506. If the set KS is not empty (NO at step 1505), the process goes back to step 1502.

At step 1506, the database resource conflict control unit 108 returns the to-be-terminated transaction list (LC) and the to-be-suspended transaction list (LS) as the return values to the database resource conflict control unit 108.

### <Exclusive Lock Conflict Control Process>

FIG. 16 is an explanatory flowchart of details of the exclusive lock conflict control process (process at step 1206) of FIG. 12.

At step 1600, the database resource conflict control unit 108 receives the to-be-terminated transaction list (LC) and the to-be-suspended transaction list (LS) from the database resource conflict control unit 108.

At step 1601, the database resource conflict control unit 108 generates a set (denoted by KX) of elements consisting of all the database objects described in the field (1105) describing database objects having the exclusive lock acquired in a set of four fields corresponding to the transaction identifier T of the transaction profile information 114, and the process goes to step 1207.

At step 1602, the database resource conflict control unit 108 selects one database object (denoted by DX) from the database objects included in the set KX and removes the database object from the set KX.

At step 1603, the database resource conflict control unit 108 refers to the exclusive resource management information 225 to detect the transaction processes acquiring the shared lock or the exclusive lock for the database object DX and checks whether the detected transaction processes include a transaction process having a priority value smaller (a priority lower) than the priority described in the priority definition information 104. If the corresponding transaction process is included (YES at step 1603), the process goes to step 1604. If the corresponding transaction process is not included (No at step 1603), the process goes to step 1605.

At step 1604, the database resource conflict control unit 108 adds to the LC all the transaction processes having the values smaller (priorities lower) than the priority described in the priority definition information 104 among the transaction processes acquiring the shared lock or the exclusive lock for the database object DX.

At step 1605, the database resource conflict control unit 108 checks whether the set KX is empty. If the set KX is empty (YES at step 1605), the process goes to step 1606. If the set KX is not empty (NO at step 1605), the process goes back to step 1602.

At step 1606, the database resource conflict control unit 108 returns the to-be-terminated transaction list (LC) and the to-be-suspended transaction list (LS) as the return values to the database resource conflict control unit 108.

### <Database Cache Memory Conflict Control Process>

FIG. 17 is an explanatory flowchart of details of the database cache memory conflict control process (process at step 1207) of FIG. 12.

At step 1700, the database resource conflict control unit 108 receives the to-be-terminated transaction list (LC) from the database resource conflict control unit 108.

At next step 1701, the database resource conflict control unit 108 calculates a total value (denoted by MA) of sizes of database cache memories registered in all the transaction state management structures retained by the transaction-in-execution management list (1001) and the transaction-in-suspension management list (1002) of the transaction state management information 224.

At step 1702, the database resource conflict control unit 108 calculates a total value (denoted by MB) of sizes of database cache memories registered in the transaction state management structures of the transaction state management information 224 corresponding to all the transaction processes included in the to-be-terminated transaction list LC.

At step 1703, the database resource conflict control unit 108 sets C as a size (capacity) of the database cache memory available to the database management system program 212 and checks whether a value (C-(MA-MB)) obtained by subtracting (MA-MB) from C is smaller than the value of the database cache memory described in the field (702) describing a value (necessary amount) of a database resource in the database resource acquisition schedule information 105. If the value is smaller (YES at step 1703), the process goes to step 1704. If the value is not smaller (NO at step 1703), the process goes to step 1706.

At step 1704, the database resource conflict control unit 108 checks whether a transaction state management structure having the priority value (1012) smaller than the priority value described in the priority definition information 104 exists among the transaction processes corresponding to the transaction identifiers registered in the transaction state management structures retained in the transaction-in-execution management list (1001) and the transaction-in-suspension management list (1002) of the transaction state management information 224 except the transaction processes included in the set LC. If the corresponding transaction state management structure exists (YES at step 1704), the process goes to step 1705. If the corresponding transaction state management structure does not exist (NO at step 1704), the process goes to step 1707.

At step 1705, the database resource conflict control unit 108 adds to the LC the transaction process corresponding to the transaction state management structure having the smallest priority value (1012) among the transaction processes corresponding to the transaction identifiers registered in the transaction state management structures retained in the transaction-in-execution management list (1001) and the transaction-in-suspension management list (1002) of the transaction state management information 224 except the transaction processes included in the set LC, and the process goes back to step 1702.

At step 1706, the database resource conflict control unit 108 sets OFF for the flag indicating a failure of resolution of the database cache memory conflict, and the process goes to step 1708.

At step 1707, the database resource conflict control unit 108 sets ON for the flag indicating a failure of resolution of the database cache memory conflict, and the process goes to step 1708.

At step 1708, the database resource conflict control unit 108 returns the to-be-terminated transaction list (LC) and the flag indicating a failure of resolution of the database cache memory conflict as the return values to the database resource conflict control unit 108.

### <I/O Device Conflict Control Process>

FIG. 18 is an explanatory flowchart of details of the I/O device conflict control process (process at step 1209) of FIG. 18.

At step 1800, the database resource conflict control unit 108 receives the to-be-terminated transaction list (LC) and the to-be-suspended transaction list (LS) from the database resource conflict control unit 108.

At next step 1801, the database resource conflict control unit 108 acquires names of all the tables described in the field (1102) describing tables to be accessed in a set of four fields including the transaction identifier T of the transaction profile information 114, refers to the database configuration information 115 to acquire names of all the databases with the acquired tables generated, and acquires names of all the I/O devices with the acquired databases generated to generate a set (denoted by D) of elements consisting of all the acquired I/O devices.

At step 1802, the database resource conflict control unit 108 adds to the LS all the transaction processes corresponding to the transaction identifiers registered in the transaction state management structures having the priority values (1012) smaller than the priority value described in the priority definition information 104 among the transaction processes corresponding to the transaction identifiers registered in the transaction state management structures retained in the transaction-in-execution management list (1001) of the transaction state management information 224 except the transaction processes included in the LC.

At step 1803, the database resource conflict control unit 108 generates a new set TLS of elements consisting of transaction processes and adds all the transaction processes included in the LS to the TLS.

At step 1804, the database resource conflict control unit 108 selects one transaction process (denoted by Ti) included in the TLS and deletes the Ti from the TLS.

At step 1805, the database resource conflict control unit 108 acquires names of all the tables described in the field (1102) describing tables to be accessed in a set of four fields including the transaction identifier of the transaction process Ti of the transaction profile information 114, refers to the database configuration information 115 to acquire names of all the databases with the acquired tables generated, and acquires names of all the I/O devices with the acquired databases generated to generate a set (denoted by Di) of elements consisting of all the acquired I/O devices.

At step 1806, the database resource conflict control unit 108 checks whether a common element (I/O device) exists between the set D and the set Di. If a common element exists (YES at step 1806), the process goes to step 1808. If no common element exists (NO at step 1806), the process goes to step 1807.

At step 1807, the database resource conflict control unit 108 deletes the transaction process Ti from the set LS.

At step 1808, the database resource conflict control unit 108 checks whether no element exists in the set TLS (whether the set TLS is empty). If no element exists (empty) (YES at step 1808), the process goes to step 1809. If an element exists (not empty) (NO at step 1808), the process goes to step 1804.

At step 1809, the database resource conflict control unit 108 returns the to-be-terminated transaction list (LC) and the to-be-suspended transaction list (LS) as the return values to the database resource conflict control unit 108.

As described above, according to the transaction parallel control method of the embodiment, while other transaction processes are being executed or suspended, if the DBMS 100 receives an instruction for a transaction process having a priority higher than the transaction processes being executed or suspended, the DBMS 100 judges a conflict situation of database resources between the transaction processes being executed or suspended and the requested transaction process and appropriately determines a transaction process to be terminated or suspended. Therefore, a loss of update data may be reduced to the minimum.

Since developers of devices and applications may execute a plurality of transaction processes in parallel without considering the combination and order of transaction processes to be controlled in parallel, troubles of the development of devices and applications are alleviated. This enables reduction of labor costs required for the development of devices and applications.

The above description of the embodiment is for the purpose of facilitating the understanding of the present invention and does not limit the present invention. The present invention may be altered or modified without departing from the spirit thereof and, of course, the present invention includes equivalents thereof.

What is claimed is:

1. A transaction parallel control method in a database management system used by applications, comprising the steps of:
receiving an instruction for requesting a transaction process from a first application and receiving transaction identifier information including an identifier of the transaction process, priority definition information including a priority of the transaction process, and database resource acquisition schedule information including a type and a value of a database resource to be acquired at the time of execution of the transaction process;
comparing the priority of the transaction process input from the first application with a priority of a transaction process instructed from a second application if the transaction process instructed from the second application different from the first application is being executed or suspended;
judging a database resource conflict between the transaction process instructed from the first application and the transaction processes being executed or suspended if the priority of the transaction process instructed from the first application is higher than the transaction process instructed from the second application as a result of the comparison;
determining a transaction process to be suspended or terminated based on a type and a value of a database resource acquired by the transaction processes being executed or suspended and a type and a value of a database resource to be acquired by the transaction process instructed from the first application;
executing the transaction process instructed from the first application by acquiring a value described in the database resource acquisition schedule information for the type of the database resource included in the database resource acquisition schedule information after suspension or termination of the transaction process to be suspended or terminated is completed; and
restarting the execution of the suspended transaction process after the execution of the transaction process instructed from the first application is completed,
wherein the steps are carried out by the database management system.

2. The transaction parallel control method of claim 1, wherein
the database resource is one or a combination of a plurality of items of a database cache memory that is a memory area for the database management system temporarily storing data during the execution of the transaction process, exclusion that is a shared lock and an exclusive lock of database objects acquired during the execution of the transaction process, and an I/O device use right for writing and reading data to/from an I/O device storing a database.

3. The transaction parallel control method of claim 2, wherein
the database resource is the database cache memory, wherein
the database management system has a data structure that retains a size of the database cache memory acquired by the transaction process being executed or suspended, wherein
at the step of judging the database resource conflict, the database management system judges that the database cache memory conflict occurs if a value obtained by subtracting a total size of the database cache memory acquired by the transaction process being executed or suspended from a total capacity of the database cache memory available to the database management system is smaller than a necessary amount of the database cache memory included in the database resource acquisition schedule information, and wherein
at the step of determining the transaction process to be terminated, if the database cache memory conflict occurs as a result of the judgment, the database management system determines a transaction process to be terminated by selecting a minimum number of transaction processes in ascending order of priority from transaction processes being executed or suspended and having priorities lower than the priority included in the priority definition information such that a value obtained by subtracting a total size of the database cache memory acquired by the transaction process being executed or suspended from a total capacity of the database cache memory available to the database management system and adding a total size of the database cache memory acquired by the transaction process to be terminated becomes larger than or equal to a necessary amount of the database cache memory included in the database resource acquisition schedule information.

4. The transaction parallel control method of claim 2, wherein
the database resource is the exclusion that is a shared lock or an exclusive lock of database objects acquired during execution of a transaction process, wherein
the database management system has a data structure that retains a list of database objects having the shared lock and the exclusive lock acquired by the transaction processes being executed or suspended, and
transaction profile information that is a data structure retaining the database objects having the shared lock and the exclusive lock acquired during the execution of transaction processes in correlation with identifiers of the transaction processes, wherein
at the step of judging the database resource conflict, the database management system judges whether a database object is an object for which the transaction process requested from the first application acquires the shared lock or the exclusive lock and judges that an exclusion conflict occurs if the transaction process being executed or suspended acquires the exclusive lock for the database object for which the transaction process requested from the first application acquires the shared lock or if the transaction process being executed or suspended acquires the shared lock or the exclusive lock for the database object for which the transaction process requested from the first application acquires the exclusive lock, and wherein
at the step of determining the transaction process to be terminated, if the exclusion conflict occurs as a result of the judgment, the database management system determines that the transaction processes to be terminated are a transaction process acquiring the exclusive lock for the database object for which the transaction process requested from the first application acquires the shared lock and a transaction process acquiring the shared lock or the exclusive lock for the database object for which the transaction process requested from the first application acquires the exclusive lock among transaction processes being executed or suspended and having priorities lower than the priority included in the priority definition information.

5. The transaction parallel control method of claim 2, wherein
the database resource is the I/O device use right, wherein
the database management system has a data structure that retains a list of I/O devices to be used by the transaction process requested from the first application, transaction processes being executed, and transaction processes being suspended, wherein
at the step of judging the database resource conflict, the database management system judges that an I/O device use right conflict occurs if the transaction process being executed or suspended is using the I/O device to be used by the transaction process requested from the first application, and wherein
at the step of determining the transaction process to be terminated, if the I/O device use right conflict occurs as a result of the judgment, the database management system determines that the transaction process to be suspended is a transaction process using the I/O device to be used by the transaction process requested from the first application among transaction processes being executed or suspended and having priorities lower than the priority included in the priority definition information.

6. The transaction parallel control method of claim 1, wherein
the database management system receives an instruction for requesting the transaction process from the first application and receives available memory area information including an address of a memory area available for the purpose of executing the transaction process.

7. The transaction parallel control method of claim 6, wherein
the available memory area information includes either a valid address of a memory area available for the purpose of executing the transaction process or an invalid address of a memory area representing the absence of a memory area available for the purpose of executing the transaction process.

8. The transaction parallel control method of claim 7, wherein
if the available memory area information includes a valid address of a memory area available for the purpose of executing the transaction process,
the transaction parallel control method further comprises the steps of
checking whether the transaction process instructed from the first application is allocatable to a database task that executes the transaction process after suspension or termination of the transaction process to be suspended or terminated is completed,
executing the transaction process instructed from the first application if the transaction process is allocatable to the database task as a result of the checking, and
executing the transaction process instructed from the first application by generating a database task that executes the transaction process at an address of a memory area included in the available memory area information if the transaction process is not allocatable to the database task as a result of the checking, wherein
the steps are carried out by the database management system.

9. The transaction parallel control method of claim 7, wherein
if the available memory area information includes an invalid address representing the absence of a memory area available for the purpose of executing the transaction process,
the transaction parallel control method further comprises the steps of
checking whether the transaction process instructed from the first application is allocatable to a database task that executes the transaction process after suspension or termination of the transaction process to be suspended or terminated is completed,
executing the transaction process instructed from the first application if the transaction process is allocatable to the database task as a result of the checking,
saving into a context saving area a context consisting of register information that is a snapshot of a register value, runtime stack information that is a snapshot of a memory area retaining a runtime stack, and global variable area information that is a snapshot of a memory area retaining a global variable of a database task allocated to the transaction process being suspended if the transaction process is not allocatable to the database task as a result of the checking,
allocating the transaction process instructed from the first application to the database task with the context saved to execute the transaction process instructed from the first application, and
recovering the context from the context saving area after the execution of the transaction process instructed from the first application is completed, and wherein
the steps are carried out by the database management system.

10. A database management system comprising:
a transaction process request accepting unit that receives an instruction for requesting a transaction process from a first application, the transaction process request accepting unit receiving transaction identifier information including an identifier of the transaction process, priority definition information including a priority of the transaction process, and database resource acquisition schedule information including a type and a value of a database resource to be acquired at the time of execution of the transaction process, the transaction process request accepting unit comparing the priority of the transaction process input from the first application with a priority of a transaction process instructed from a second application if the transaction process instructed from the second application different from the first application is being executed or suspended;
a database resource conflict control unit that judges a database resource conflict between the transaction process instructed from the first application and the transaction processes being executed or suspended if the priority of the transaction process instructed from the first application is higher than the transaction process instructed from the second application as a result of the comparison, the database resource conflict control unit determining a transaction process to be suspended or terminated based on a type and a value of a database resource acquired by the transaction processes being executed or suspended and a type and a value of a database resource to be acquired by the transaction process instructed from the first application; and
a database task control processing unit that executes the transaction process instructed from the first application by acquiring a value described in the database resource acquisition schedule information for the type of the database resource included in the database resource acquisition schedule information after suspension or termination of the transaction process to be suspended or terminated is completed, the database task control processing unit restarting the execution of the suspended transaction process after the execution of the transaction process instructed from the first application is completed.

11. The database management system of claim 10, wherein
the database resource is one or a combination of a plurality of items of a database cache memory that is a memory area for the database management system temporarily storing data during the execution of the transaction process, exclusion that is a shared lock and an exclusive lock of database objects acquired during the execution of the transaction process, and an I/O device use right for writing and reading data to/from an I/O device storing a database.

12. The database management system of claim 11, wherein
the database resource is the database cache memory, wherein
the database management system has a data structure that retains a size of the database cache memory acquired by the transaction process being executed or suspended, wherein
when judging the database resource conflict, the database resource conflict control unit judges that the database cache memory conflict occurs if a value obtained by subtracting a total size of the database cache memory acquired by the transaction process being executed or suspended from a total capacity of the database cache memory available to the database management system is smaller than a necessary amount of the database cache memory included in the database resource acquisition schedule information, and wherein
when determining the transaction process to be terminated, if the database cache memory conflict occurs as a result of the judgment, the database resource conflict control unit determines a transaction process to be terminated by selecting a minimum number of transaction processes in ascending order of priority from transaction processes being executed or suspended and having priorities lower than the priority included in the priority definition information such that a value obtained by subtracting a total size of the database cache memory acquired by the transaction process being executed or suspended from a total capacity of the database cache memory available to the database management system and adding a total size of the database cache memory acquired by the transaction process to be terminated becomes larger than or equal to a necessary amount of the database cache memory included in the database resource acquisition schedule information.

13. The database management system of claim 11, wherein
the database resource is the exclusion that is a shared lock or an exclusive lock of database objects acquired during execution of a transaction process, wherein
the database management system has a data structure that retains a list of database objects having the shared lock and the exclusive lock acquired by the transaction processes being executed or suspended, and
transaction profile information that is a data structure retaining the database objects having the shared lock and the exclusive lock acquired during the execution of transaction processes in correlation with identifiers of the transaction processes, wherein
when judging the database resource conflict, the database resource conflict control unit judges whether a database object is an object for which the transaction process requested from the first application acquires the shared lock or the exclusive lock and judges that an exclusion conflict occurs if the transaction process being executed or suspended acquires the exclusive lock for the database object for which the transaction process requested from the first application acquires the shared lock or if the transaction process being executed or suspended acquires the shared lock or the exclusive lock for the database object for which the transaction process requested from the first application acquires the exclusive lock, and wherein
when determining a transaction process to be terminated, if the exclusion conflict occurs as a result of the judgment, the database resource conflict control unit determines that the transaction processes to be terminated are a transaction process acquiring the exclusive lock for the database object for which the transaction process requested from the first application acquires the shared lock and a transaction process acquiring the shared lock or the exclusive lock for the database object for which the transaction process requested from the first application acquires the exclusive lock among transaction processes being executed or suspended and having priorities lower than the priority included in the priority definition information.

14. The database management system of claim 11, wherein
the database resource is the I/O device use right, wherein
the database management system has a data structure that retains a list of I/O devices to be used by the transaction process requested from the first application, transaction processes being executed, and transaction processes being suspended, wherein
when judging the database resource conflict, the database resource conflict control unit judges that an I/O device use right conflict occurs if the transaction process being executed or suspended is using the I/O device to be used by the transaction process requested from the first application, and wherein
when determining the transaction process to be terminated, if the I/O device use right conflict occurs as a result of the judgment, the database resource conflict control unit determines that the transaction process to be suspended is a transaction process using the I/O device to be used by the transaction process requested from the first application among transaction processes being executed or suspended and having priorities lower than the priority included in the priority definition information.

15. The database management system of claim 10, wherein
the database management system receives an instruction for requesting the transaction process from the first application and receives available memory area information including an address of a memory area available for the purpose of executing the transaction process.

16. The database management system of claim 15, wherein
the available memory area information includes either a valid address of a memory area available for the purpose of executing the transaction process or an invalid address of a memory area representing the absence of a memory area available for the purpose of executing the transaction process.

17. The database management system of claim 16, wherein
if the available memory area information includes a valid address of a memory area available for the purpose of executing the transaction process,
the database management system checks whether the transaction process instructed from the first application is allocatable to a database task that executes the transaction process after suspension or termination of the transaction process to be suspended or terminated is completed,
executes the transaction process instructed from the first application if the transaction process is allocatable to the database task as a result of the checking, and
executes the transaction process instructed from the first application by generating a database task that executes the transaction process at an address of a memory area included in the available memory area information if the transaction process is not allocatable to the database task as a result of the checking.

18. The database management system of claim 16, wherein
if the available memory area information includes an invalid address representing the absence of a memory area available for the purpose of executing the transaction process,
the database management system checks whether the transaction process instructed from the first application is allocatable to a database task that executes the transaction process after suspension or termination of the transaction process to be suspended or terminated is completed,
executes the transaction process instructed from the first application if the transaction process is allocatable to the database task as a result of the checking,
saves into a context saving area a context consisting of register information that is a snapshot of a register value, runtime stack information that is a snapshot of a memory area retaining a runtime stack, and global variable area information that is a snapshot of a memory area retaining a global variable of a database task allocated to the transaction process being suspended if the transaction process is not allocatable to the database task as a result of the checking,
allocates the transaction process instructed from the first application to the database task with the context saved to execute the transaction process instructed from the first application, and
recovering the context from the context saving area after the execution of the transaction process instructed from the first application is completed.

19. A computer-readable medium containing a program that causes an information processing apparatus to implement the steps of:
receiving an instruction for requesting a transaction process from a first application and receiving transaction identifier information including an identifier of the transaction process, priority definition information including a priority of the transaction process, and database resource acquisition schedule information including a type and a value of a database resource to be acquired at the time of execution of the transaction process;
comparing the priority of the transaction process input from the first application with a priority of a transaction process instructed from a second application if the transaction process instructed from the second application different from the first application is being executed or suspended,
judging a database resource conflict between the transaction process instructed from the first application and the transaction processes being executed or suspended if the priority of the transaction process instructed from the first application is higher than the transaction process instructed from the second application as a result of the comparison;
determining a transaction process to be suspended or terminated based on a type and a value of a database resource acquired by the transaction processes being executed or suspended and a type and a value of a database resource to be acquired by the transaction process instructed from the first application;
executing the transaction process instructed from the first application by acquiring a corresponding value for the type of the database resource included in the database resource acquisition schedule information after suspension or termination of the transaction process to be suspended or terminated is completed; and
restarting the execution of the suspended transaction process after the execution of the transaction process instructed from the first application is completed.
